(19) United States
(12) Patent Application Publication
(10) Pub. No.: US 2020/0044917 A1
(43) Pub. Date: Feb. 6, 2020

(54) Zero touch provisioning script to provision network elements over unnumbered interfaces

(71) Applicant: Ciena Corporation, Hanover, MD (US)

(72) Inventor: Cheng Peng, Nepean (CA)

(21) Appl. No.: 16/050,854

(22) Filed: Jul. 31, 2018

(51) Int. Cl. H04L 12/24; H04L 29/12; H04L 29/08

(52) U.S. Cl. CPC H04L 41/0806; H04L 67/1061; H04L 61/2015; H04L 41/0886

(57) ABSTRACT

Systems and methods of low or zero touch provisioning of a network element over an unnumbered interface include, subsequent to installation and connection of the network element to a network, obtaining an Internet Protocol (IP) address from a Dynamic Host Configuration Protocol (DHCP) server through a DHCP Relay Agent, wherein the IP address is for another interface associated with the network element; performing routing configuration of the unnumbered interface based on data obtained from the DHCP Relay Agent; requesting a script from an external server subsequent to the routing configuration; and receiving the script from the external server and executing the script to perform configuration of the network element.

### FIELD OF THE DISCLOSURE

The present disclosure generally relates to networking systems and methods. More particularly, the present disclosure relates to low or zero touch provisioning systems and methods using a script to provision network elements over unnumbered interfaces.

### BACKGROUND OF THE DISCLOSURE

Networks (e.g., optical, packet, etc.) are realized through physical network elements interconnected to one another. A network element (NE) is a collection of hardware and software configured to implement a node or device in the network. For example, network elements can be implemented via modules which fit into a chassis, a self-contained so-called pizza box, as well as multiple chassis physically connected to one another. Network elements are geographically deployed such as in Central Offices (COs), data centers, huts/shelters, customer premises, etc. The conventional approach to installation and provisioning includes field technicians installing, powering up the network element, and configuring provisioning information to enable the network element to communicate on the network. Zero Touch Provisioning (ZTP) includes automatic configuration of the network element once it is powered up and connected to the network such as to automatically download provisioning information. Low Touch Provisioning (LTP), similar to zero touch provisioning, includes automatic configuration of the network element once the network element is at a minimum configuration for network communication. Advantageously, these approaches to provisioning significantly reduce turn up time and configuration errors.

Further, network operators are utilizing a user-defined script (e.g., Python script) which is executed on the ZTP network element in order to provision the network element. The scripts are not known in advance. The ZTP NE is required to pull the script down to the network element and allows the script to be executed in an execution environment such as Linux with Python support. The script is responsible for communicating with external configuration servers to download software images, configuration files, etc. The script then interacts with the NEs operating system itself to perform system configuration, configuration modification, software upgrade, operational status reporting, etc. Of note, the conventional approach using a script requires a numbered interface on the ZTP network element. As described herein, a numbered interface has an Internet Protocol (IP) address.

### BRIEF SUMMARY OF THE DISCLOSURE

In an embodiment, a method of low or zero touch provisioning of a network element over an unnumbered interface includes, subsequent to installation and connection of the network element to a network, obtaining an Internet Protocol (IP) address from a Dynamic Host Configuration Protocol (DHCP) server through a DHCP Relay Agent, wherein the IP address is for another interface associated with the network element; performing routing configuration of the unnumbered interface based on data obtained from the DHCP Relay Agent; requesting a script from an external server subsequent to the routing configuration; and receiving the script from the external server and executing the script to perform configuration of the network element. The performing routing configuration can include the DHCP Relay Agent providing Link Layer Discovery Protocol (LLDP) packets to the network element. The data obtained from the DHCP Relay Agent can be in a protocol identity Type-Length-Value (TLV) in the LLDP packets. The routing configuration can be one of Open Shortest Path First (OSPF) and Intermediate System-Intermediate System (ISIS). The performing routing configuration can include the network element sniffing packets sent by the DHCP Relay Agent on the unnumbered interface. The obtaining the IP address can utilize option 82 from the DHCP Relay Agent to the DHCP server. The requesting the script can utilize DHCP option 66 or 67. The method can further include, prior to the installation and the connection, storing commissioning data and the script for the network element.

In another embodiment, a network element includes one or more modules; one or more switch modules interconnecting the one or more modules; and a plurality of interfaces communicatively coupled to the one or more modules and the one or more switch modules, at least one of the plurality of interfaces includes an unnumbered interface, wherein subsequent to installation and connection of the one or more modules to a network, the unnumbered interface obtains an Internet Protocol (IP) address from a Dynamic Host Configuration Protocol (DHCP) server through a DHCP Relay Agent, wherein the IP address is for another interface of the plurality of interfaces, wherein a routing configuration is performed for the unnumbered interface based on data obtained from the DHCP Relay Agent, and wherein, subsequent to the routing configuration, a script is requested via the unnumbered interface from an external server, and, subsequent to receipt of the script, the script is executed to perform configuration of the network element. The routing configuration can include receipt of Link Layer Discovery Protocol (LLDP) packets from the DHCP Relay Agent. The data obtained from the DHCP Relay Agent can be in a protocol identity Type-Length-Value (TLV) in the LLDP packets. The routing configuration can be one of Open Shortest Path First (OSPF) and Intermediate System-Intermediate System (ISIS). The routing configuration can include the network element sniffing packets sent by the DHCP Relay Agent on the unnumbered interface. The IP address can be obtained using option 82 from the DHCP Relay Agent to the DHCP server. The script can be requested using DHCP option 66 or 67. Prior to the installation and the connection, commissioning data and the script can be stored for the network element.

In a further embodiment, a Dynamic Host Configuration Protocol (DHCP) Relay Agent for low or zero touch provisioning includes a processor; and memory storing instructions that, when executed, cause the processor to receive and relay Dynamic Host Configuration Protocol (DHCP) messages between an unnumbered interface on a network element and a DHCP server, wherein the DHCP messages provide an Internet Protocol (IP) address which is for another interface associated with the network element, and provide routing configuration data to the unnumbered interface such that the unnumbered interface configures routing, wherein the routing configuration is one of Open Shortest Path First (OSPF) and Intermediate System-Intermediate System (ISIS), wherein the network element utilizes the routing configuration to configure the unnumbered interface such that the unnumbered interface requests and receives a script for configuration of the network element. The routing configuration data can be provided via Link Layer Discovery Protocol (LLDP) packets to the unnumbered interface. The LLDP packets can include a protocol identity Type-Length-Value (TLV). The DHCP messages can be provided via DHCP option 82 between the DHCP Relay Agent to the DHCP server.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a network with network elements (NE);

FIG. 2 is a flow diagram of a commissioning process between an operator, an equipment depot, network servers, and a field location;

FIG. 3 is a network diagram of a network with network elements connected to a Data Communication Network (DCN) for provisioning information and the like;

FIG. 4 is a network diagram of a Dynamic Host Configuration Protocol (DHCP) Relay Agent between the network element and the DHCP server over the DCN;

FIG. 5 is a flowchart of a DHCP Relay Agent process adapted to support configuration file distribution using DHCP packets over unnumbered interfaces;

FIG. 6 is a block diagram of an example implementation of the network element;

FIG. 7 is a flow diagram of the network element connecting to the DHCP Relay Agent through an unnumbered interface with the DHCP Relay Agent performing option conversion;

FIG. 8 is a flowchart of an LTP/ZTP process performed by the network element;

FIG. 9 is a flowchart of a DHCP Relay Agent process;

FIG. 10 is a network diagram of a network with a network element with multiple numbered interfaces communicating to a single DHCP server;

FIG. 11 is a network diagram of a network for zero touch provisioning over a numbered interface with a single DHCP server and FTP server;

FIG. 12 is a network diagram of a network for zero touch provisioning over multiple numbered interfaces with a single DHCP server and FTP server;

FIG. 13 is a network diagram of a network for zero touch provisioning over multiple numbered interfaces with multiple DHCP servers and FTP servers;

FIG. 14 is a flowchart of a process for zero touch provisioning of a network element having multiple numbered interfaces;

FIG. 15 is a network diagram of a network illustrating zero touch provisioning of network elements over a layer 2 network;

FIG. 16 is a network diagram of a network illustrating zero touch provisioning of network elements over a layer 3 network;

FIG. 17 is a network diagram of a network illustrating the problems in zero touch provisioning of network elements where a NAT gateway prevents a DHCP Relay Agent from communicating to the DHCP server;

FIG. 18 is a network diagram of a network illustrating zero touch provisioning of the network elements through the NAT gateway;

FIG. 19 is a flowchart of a process for sending a DHCP packet from a DHCP client in the network element to the DHCP server through the NAT gateway;

FIG. 20 is a flowchart of a process for sending a DHCP packet from the DHCP server to the DHCP client in the network element through the NAT gateway;

FIG. 21 is a flowchart of a process implemented by a DHCP Relay Agent;

FIG. 22 is a flowchart of a process of low or zero touch provisioning of a network element through a Network Address Translation (NAT) gateway, implemented via a first Dynamic Host Configuration Protocol (DHCP) Relay Agent operating at the NAT gateway;

FIG. 23 is a flowchart and diagram of a script process for ZTP provisioning;

FIG. 24 is a flow diagram of a scripting process with a network element connecting to the DHCP Relay Agent through a numbered interface;

FIG. 25 is a flow diagram of the scripting process of FIG. 24 with a network element connecting to the DHCP Relay Agent through an unnumbered interface, illustrating the problems associated therewith;

FIG. 26 is a flow diagram of a scripting process with a network element connecting to the DHCP Relay Agent through an unnumbered interface and with the network element learning the routing configuration;

FIG. 27 is a block diagram of a protocol identity Type-Length-Value (TLV) for use in the LLDP approach of the scripting process of FIG. 26;

FIG. 28 is a network diagram with a security service introduced in a ZTP system;

FIG. 29 is a network diagram with the security service operating collaboratively with the DHCP RA to provide an encrypted configuration transfer from the DHCP RA to the DHCP client over an unnumbered link;

FIG. 30 is a network diagram where there are multiple security services in a multi-vendor environment where multiple vendor's devices are mixed within the same networks; and

FIG. 31 is a flow diagram of message sequences using the security service of FIGS. 28-30.

### DETAILED DESCRIPTION OF THE DISCLOSURE

In an embodiment, the present disclosure relates to low or zero touch provisioning systems and methods using a script to provision network elements over unnumbered interfaces. The systems and methods provide operators the maximal flexibility to choose where and when to download a configuration or software image through any protocol and security policy they choose. The systems and methods address access over an unnumbered interface using a script. An approach to resolve access over the unnumbered interface is to advertise the route to the ZTP network element to the Data Communication Network (DCN) networks through a routing protocol. In order to achieve that, the systems and methods operate the ZTP NE to learn a routing configuration of a DHCP Relay Agent (RA) and derive the routing configuration accordingly, which enables the communication to be established on the DCN for ZTP configuration such as via a script.

In another embodiment, the present disclosure relates to low or zero touch provisioning systems and methods of network elements through a Network Address Translation (NAT) gateway. The systems and methods allow a centralized DHCP server such as residing in operators' DCN to service ZTP NEs, without requiring the DHCP server to reside in the same private IP address space as a network element. The systems and methods do not require extra provisioning, protocols, and services in order to operate. The systems and methods use standard network configuration and are compatible with the DHCP standard so that it can operate with any DHCP server. The systems and methods can be applied to both layer 2 networks and layer 3 networks.

In a further embodiment, the present disclosure relates to low or zero touch provisioning systems and methods of network elements over unnumbered interfaces. This is particularly applicable to network elements which are turned up with unnumbered interfaces, e.g., Optical Service Channels (OSCs), overhead channels on optical ports, Ethernet point-to-point interfaces to shelf controllers or processors, etc. The low or zero touch provisioning systems and methods use a DHCP relay agent on a network element as a delegator of a DHCP client to obtain configuration, package it into DHCP packets and forward it to the ZTP NE client. The approach is able to deliver the device-specific configuration over the unnumbered point-to-point interface or link.

In a further embodiment, the present disclosure relates to zero touch provisioning over numbered interfaces. Networks (e.g., optical, packet, etc.) are realized through physical network elements interconnected to one another. Network elements are geographically deployed such as in Central Offices (COs), data centers, huts/shelters, customer premises, etc. The conventional approach to installation and provisioning includes field technicians installing, powering up the network element, and configuring provisioning information to enable the network element to communicate on the network. Zero touch provisioning includes automatic configuration of the network element once it is powered up and able to communicate on the network such as to automatically download provisioning information. Low touch provisioning, similar to zero touch provisioning, includes automatic configuration of the network element once the network element is at a minimum configured for network communication. Advantageously, these approaches to provisioning significantly reduce turn up time and configuration errors.

In a further embodiment, the present disclosure relates to zero touch provisioning in a secure manner. An approach is described to provide a secure configuration transfer from the configuration server or the closest DHCP relay agent to the device without preloading any password or certificate on the device.

### One-Touch Provisioning

One-touch provisioning provides turn-up automation by removing the manual device (initial) configuration work duties/actions from the field technicians. The removal of device (initial) configuration work, along with other controller/Data Collection, Analytics, and Event (DCAE) automation, will, in turn, remove the need for craft interfaces and software applications. This is expected to simplify the field operations in supporting a dynamic mix of multiple-vendor deployment environment by focusing on physical cabling and equipment slotting aspect of the network while relying on a controller and northbound applications to perform the rest of Fault, Configuration, Accounting, Performance, Security (FCAPS) functions. Advantageously, one-touch provisioning has no initial “touch” in the field; field operations focus on physical cabling and equipment slotting aspect of the network, configuration work does not rely on craft interfaces but on the controller and northbound applications, etc. The “touch” happens when a controller correlates a network element to its configuration through the unique identifier of the network element.

### Zero-Touch Provisioning

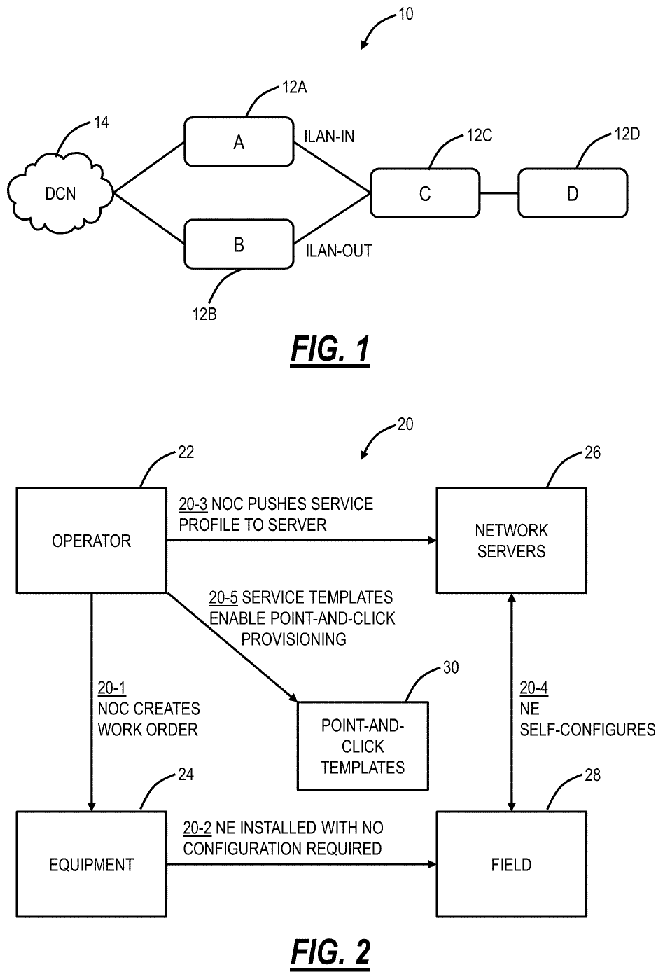

Unlike one-touch turn-up where the controller correlates the physical NE to the provisioning data, zero touch turn-up requires software/firmware functionality to make such a correlation automatically. The network element may not be identified by a unique ID since it is not known in advance by the northbound applications. Instead, the provisioning data is determined by the location/connectivity of the network element, i.e., topology information. The identity of the network element can be described by the identity of its neighboring network element(s) and the port(s) connecting therein. FIG. 1 is a network diagram of a network 10 with network elements (NE) 12 (labeled as NEs 12A, 12B, 12C, 12D). For example, the identity of the NE 12C can be described as a specific type of shelf which the NE 12A connects to via an Inter-shelf Local Area Network (ILAN)-IN. ILAN is an Ethernet port between the network elements 12. The NE 12C also can be described as the specific type of shelf which the NE 12B connects to via ILAN-OUT. Both descriptions are valid. The NEs 12 can connect to a Data Communication Network (DCN) 14. The configuration is validated on the receiving NE 12.

### NE Provisioning

FIG. 2 is a flow diagram of a commissioning process 20 between an operator 22, an equipment depot 24, network servers 26, and a field location 28. The operator 22 can include engineering, planning, a Network Operations Center (NOC), etc., i.e., personnel associated with a service provider operating and planning the network. The equipment depot 24 can be a warehouse, a vendor, etc., i.e., a location where network element equipment is located, manufactured, stored, etc. The network servers 26 communicate on the DCN 14 and can include provisioning data for the network elements. Finally, the field location 28 can be a Central Office (CO), Data Center, customer premises, cabinet, shelter, hut, etc., i.e., any location where network elements are deployed in the network.

The commissioning process 20 initiates when the operator 22 creates a work order (step 20-1), i.e., a request for a new network element. The work order is provided to the equipment depot 24 which provides the network element to the field location 28 where the network element is installed with no configuration required (step 20-2). The process of installing the network element at the field location 28 includes physical installation, i.e., installing a shelf in a rack, installing modules or line cards in the shelf, etc., and cabling, i.e., cabling optical and/or electrical interfaces, power, telemetry, etc. Once physically installed and cabled, the network element is powered on. It is at this point of physically powering on the network element where low-touch or zero-touch provisioning begins for the NE. In parallel or associated to the work order 201, the operator 22 provides a service profile, i.e., configuration or provisioning data, to the network servers 26 over the DCN 14 (step 26). Once the network element is powered up at the field location 28, the network element self-configures such as contacting a DHCP server on the DCN 14 for an IP address and downloading the configuration or provisioning data from the network servers 26 (step 20-4). A northbound application such as from the network servers 26 can push additional configurations. The network element now supports point-and-click provisioning via service templates 30 (step 20-5).

### Network Deployment

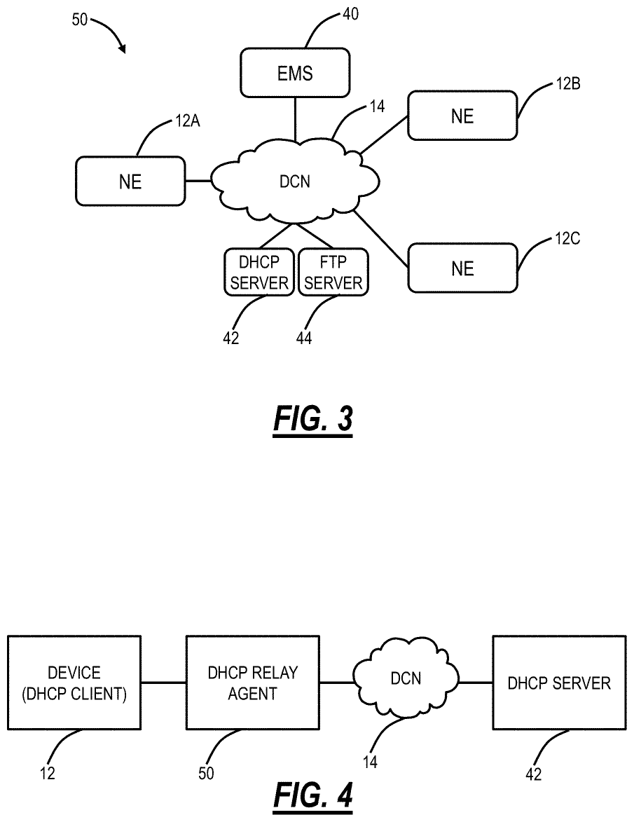

FIG. 3 is a network diagram of a network 50 with network elements 12 connected to the DCN 14 for provisioning configuration information and the like. FIG. 3 includes three network elements 12A, 12B, 12C communicatively coupled to an Element Management System (EMS) 40 via the DCN 14. The network elements 12A, 12B, 12C can include an Add/Drop Multiplexer (ADM), a Multi-Service Provisioning Platform (MSPP), a Digital Cross-Connect (DCS), an optical cross-connect, a Packet-Optical Transport System (POTS), an optical switch, a router, a switch, a WDM/DWDM terminal, an access/aggregation device, etc. That is, the network elements 12A, 12B, 12C can be any type of node which realizes/provides some functionality in the network and which requires on-site provisioning and configuration. The network elements 12 support Low Touch Provisioning (LTP) or Zero Touch Provisioning (ZTP) over the DCN 14.

FIG. 3 illustrates a configuration where the DHCP/FTP servers 42, 44 are located in a layer 3 network. This configuration reduces the EMS management complexity, relative to having the DHCP/FTP servers 42, 44 in the network such as on each of the network elements 12A, 12B, 12C. All configuration files are stored in one or a few centralized DHCP/FTP servers 42, 44. The DHCP/FTP servers 42, 44 can be located in the DCN 14 or the network elements 12. Redundancy of the DHCP/FTP servers 42, 44 is achieved by introducing another server and the number of the DHCP/FTP servers 42, 44 is not proportional to the number of network elements 12. However, this configuration requires IP reachability and the IP addresses assigned by the DHCP server 42 must be routable.

Note, in the various examples described herein, the FTP server 44 is described for containing and providing configuration information for ZTP/LTP. Those skilled in the art will recognize other protocols besides FTP are also contemplated for providing the configuration information.

### LTP/ZTP Over Unnumbered Interfaces

In various embodiments, the systems and methods support LTP/ZTP in the configuration of FIG. 3 where the network elements 12 have unnumbered interfaces to the DHCP/FTP servers 42, 44. Again, LTP/ZTP allows the network elements 12 to be provisioned and configured automatically. The network elements 12 send out a request through DHCP to the DHCP server 42 to obtain the location of its configuration. The network element 12 then downloads and installs the configuration. In the case that the network element 12 is not in the same layer 2 network with the DHCP server 42, a DHCP relay agent is employed as a mediator to forward DHCP packets between clients and servers. FIG. 4 is a network diagram of a DHCP Relay Agent 50 between the network element 12 and the DHCP server 42 over the DCN 14. The network element 12 is identified by the identity of the DHCP Relay Agent 50 as well as the local port connecting to the network element 12. The DHCP Relay Agent 50 can report such information via option 82 along with the DHCP packets sent by the network element 12 to the DHCP server 42 so that the DHCP server 42 can reply with the specific configuration to the network element 12 in terms of the information.

The approach works sufficiently if the DHCP client (the network element 12) connects over a numbered interface on the network element 12 because a routable IP address is assigned to the interface such that the network element 12 can access to the configuration. However, the technique does not work if the DHCP client (NE 12) connects over an unnumbered interface because 1) the interface does not have its own IP address and 2) the network element 12 is not reachable unless a routing protocol is configured. The routing protocol information cannot be conveyed via the DHCP protocol. Consequently, the network element 12 is not able to reach the configuration, causing ZTP/LTP to fail.

As described herein, the network element 12 includes various interfaces to connect the DCN 14 including Ethernet ports, Optical Service Channels (OSC), Overhead communication channels, etc. Again, as described herein, an unnumbered interface is an interface on the network element 12 which does not have an IP address and cannot receive an IP address which is routable from the DHCP server 42.

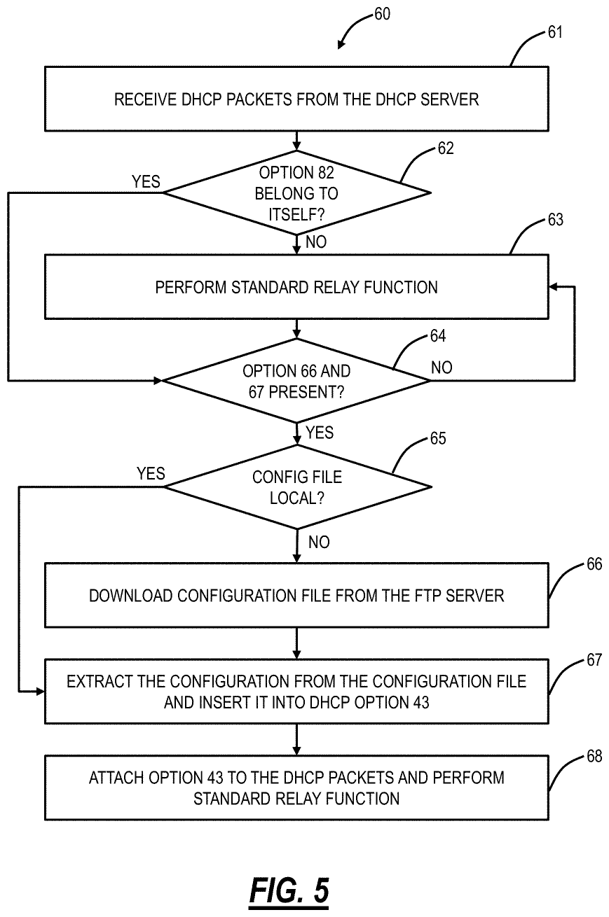

The systems and methods deliver the device-specific configuration to each NE device over unnumbered interfaces, e.g., unnumbered Ethernet point-to-point interfaces, OSC interfaces, and other optical interfaces, during ZTP/LTP. The systems and methods include modifications on the DHCP Relay Agent 50. FIG. 5 illustrates a flowchart of a DHCP Relay Agent process 60 adapted to provide configuration file distribution using DHCP packets over unnumbered interfaces.

The Bootstrap Protocol (BOOTP) [RFC951] describes an IP/User Datagram Protocol (UDP) bootstrap protocol (BOOTP) which allows a (diskless) client machine to discover its own IP address, the address of a server host, and the name of a file to be loaded into memory and executed. The Dynamic Host Configuration Protocol (DHCP) [RFC2131] provides a framework for automatic configuration of IP hosts. The document “DHCP Options and BOOTP Vendor Information Extensions” [RFC2132] describes options for DHCP, some of which can also be used with BOOTP. Additional DHCP options are described in other RFCs. The contents of RFC951, RFC2131, and RFC2132 are incorporated by reference herein. The DHCP Relay Agent 50 can be located at the network element 12 and can be any host or IP router that forwards DHCP packets between clients and servers. The DHCP Relay Agent 50 can operate as described in RFC3046, “DHCP Relay Agent Information Option,” the contents of which are incorporated by reference herein.

When the DHCP Relay Agent 50 receives DHCP packets from the DHCP server 42 (step 61), the process 60 performs the following extra steps to process the packet to support LTP/ZTP over unnumbered interfaces, diverting from the behavior of a standard DHCP relay agent. The process 60 includes checking whether the DHCP packet's option 82 belongs to the DHCP Relay Agent 50 (step 62), and if not, the process 60 includes performing standard relay functions (step 63). DHCP option 82 indicates the DHCP packet includes Relay Agent information. If the DHCP packet's option 82 belongs to the DHCP Relay Agent 50 (step 62), the process 60 includes checking whether DHCP options 66 and 67 (FTP server 44 and configuration location) are present (step 64), and if not, the process 60 includes performing standard relay functions (step 63). Note, the process 60 checks the DHCP options 66 and 67 are present to locate the FTP server 44 and the configuration location, but it is not limited to these two options. Those skilled in the art will recognize the process 60 can use any DHCP other options such as option 125, option 150, etc. to locate a configuration file. Further, while the configuration file is described with respect to the FTP server 44, the process 60 is not limited to the use of the FTP server 44; those skilled in the art recognize any file transfer technique is contemplated.

If the DHCP options 66 and 67 (FTP server 44 and configuration location) are present (step 64), the process 60 first checks whether the configuration file has been downloaded into the local storage (step 65), and if not, the process 60 includes downloading at the DHCP Relay Agent 50 a configuration file from the FTP server 44 to the local disk (step 66). When the options 66 and 67 are present, it must be determined whether the configuration file has been downloaded into the local disk before. If so, that local configuration file can be used; otherwise, the configuration file is downloaded from the FTP server 44. The local copy of the configuration file can be kept for a period of time and then can be removed.

The process 60 then includes extracting the configuration from the configuration file and inserting it into a DHCP packet with option 43 (Vendor Specific information) (step 67), and attaching option 43 to the DHCP packets and performing the standard relay function (step 68). Steps 65-68 provide an option conversion which allows the network element 12 (i.e., the DHCP client) to obtain the configuration information via DHCP packets from the DHCP server 42 through option 43. The DHCP client ignores the IP address, netmask, default route (DHCP option 3) and static route (DHCP option 33) information assigned by the DHCP server 42 because they are not needed by unnumbered interfaces. It then extracts the configuration from the DHCP option 43 and configures the network element 12 based thereon. Steps 64-66 are not restricted to employing the FTP server 44 but can be extended to other indications of the location of the configuration file. Of note, the process 60 can also operate with DHCP for IPv6 (DHCPv6). Though it is shown that the option 43 is employed to convey the configuration, other implementation may choose to use other options such as option 125 or options among 224-254. For DHCPv6, the option may be option 17 instead of option 43. Thus, if the relay agent is running on IPv6, it will insert the configuration in option 17 of DHCPv6. The options to locate the configuration file in DHCPv6 are different from DHCP.

### DHCP Relay Agent on a Network Element

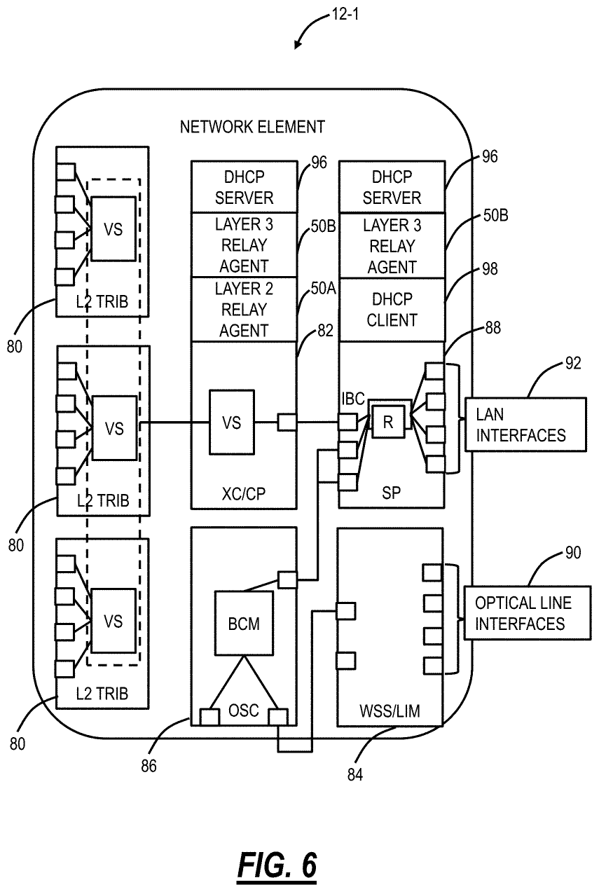

FIG. 6 is a block diagram of an example implementation of a generic network element 12-1 which can be used to implement the DHCP client 12, the DHCP relay agent 50, and/or the DHCP server 42. In this embodiment, the network element 12-1 is an optical network element supporting Layer 0 (DWDM), Layer 1 (Time Division Multiplexing (TDM) such as Optical Transport Network (OTN)), and Layer 2 (Packet). Those skilled in the art will recognize the systems and methods contemplate operation with any type of network element with unnumbered interfaces. The network element 12-1 includes Layer-2 packet modules 80, one switch module 82, one or more optical switch/line modules (wavelength switches, amplifiers) 84, optical modules (OSC) 86, and a shelf processor (SP) 88.

The Layer-2 packet interface modules 80 provide Layer-2 packet interfaces, such as layer 2 tributaries. The Layer-2 packet interface modules 80 can include Virtual Switches (VS) for distributed layer 2 switching in combination with the switch module 82. The switch module 82 is configured to switch channels, timeslots, tributary units, packets, etc. between the layer-2 packet interface modules 80. In an embodiment, the Layer-2 packet interface modules 80 can form ingress and egress virtual switches with the switch module 82 as center stage switch(es) for a three-stage switch, e.g., a three-stage Clos switch.

The optical switch/line modules 84 can be configured to provide ingress and egress to external connections on the links to/from the network element 12-1. Other configurations and/or architectures are also contemplated. The optical line modules 84 can include optical line interfaces 90 external to the network element 12-1. In an embodiment, the optical line interfaces 90 can provide connectivity to the DCN 14, such as via overhead, an OSC, etc.

The optical modules 84 can include optical amplifiers (e.g., EDFA) Etc. The shelf processor 88 can provide Operations, Administration, Maintenance, and Provisioning (OAM&P) access; user interface ports; and the like. Of note, the optical line interfaces 90 and/or the LAN interfaces 92 are unnumbered interfaces over which the LTP/ZTP is performed. Note, the LAN interfaces 92 can also include numbered interfaces.

Those of ordinary skill in the art will recognize the network element 12-1 can include other components which are omitted for illustration purposes, and that the systems and methods described herein are contemplated for use with a plurality of different network elements with the network element 12-1 presented as an example type of network element. For example, in another embodiment, the network element 12-1 may not include the switch modules 82, but rather have the corresponding functionality in the modules 86, 84 (or some equivalent). For the network element 12-1, other architectures providing ingress, egress, and switching are also contemplated for the systems and methods described herein. In general, the systems and methods described herein contemplate use with any network element providing switching of channels, timeslots, tributary units, packets, wavelengths, etc. Furthermore, the network element 12-1 is merely presented as one example network element for the systems and methods described herein.

The network element 12-1 includes a layer 2 Relay Agent 50A, a layer 3 Relay Agent 50B, DHCP servers 96, and a DHCP client 98. In an embodiment, the Relay Agents 50A, 50B can run on both the shelf processor 88 and the switch module 82. Of course, other embodiments are also contemplated. The network element 12-1 can be configured for layer 2 relay only or for layer 3 relay only. The layer 2 Relay Agent 50A can forward DHCP messages to another layer 2 port or shelf processor 88 for layer 3 relay, between the DHCP servers 96 and the DHCP client 98. The DHCP can be resolved in the layer 2 domain or the layer 3 domain depending on the location of the LTP/ZTP server (the DHCP/FTP servers 42, 44). The switch module 82 can be able to identify the port of incoming traffic.

The FTP server 44 can be referred to as a configuration server which has a provisioning profile (i.e., a configuration file) for the network element 12-1. Note, the FTP server 44 can in some embodiments be combined with the DHCP server 42. The address of the DHCP/FTP servers 42, 44 is known by the network element 12-1, the layer 2 Relay Agent 50A, and the layer 3 Relay Agent 50B. However, it is not possible for other devices such as the DHCP/FTP servers 42, 44 to address the network element 12-1 due to the unnumbered interface.

LTP/ZTP network element commissioning (provisioning) can include two stages—1) communication configuration and 2) additional network element provisioning. For the communication configuration, LTP/ZTP has to bring up the optical line interfaces 90 and/or the LAN interfaces 92 with a DHCP client enabled thereon. The DHCP Relay Agent 50A, 50B pointing to the DHCP server 42 has to be enabled on the neighboring network element 12.

The network element 12-1 negotiates with the DHCP server 42 to obtain the configuration information through, for example, option 3 for receiving a default route, option 33 for receiving a static route, option 60 for identifying vendor type when communicating with DHCP servers, option 61 for identifying a DHCP client and configuration, option 66 for the address of the FTP server 44, and option 67 for the directory on the FTP server 44 that contains the configuration or command files. The network element 12-1 can notify a northbound controller once the communication configuration is complete.

Stage 2 is for the additional network element provisioning. At this stage, the network element 12-1 is able to reach the FTP server 44. The network element 12-1 then requests the FTP server 44 to send additional configuration commands in order to provision additional services (e.g., optical, other facilities). This could be achieved by downloading a configuration file from the FTP server 44, or this could be achieved by requesting a configuration server to TELNET back to the network element 12-1 and configure it through Transaction Language-1 (TL1) commands, Command Line Interface (CLI), NETCONF, etc.

### DHCP Relay Agent Example Operations

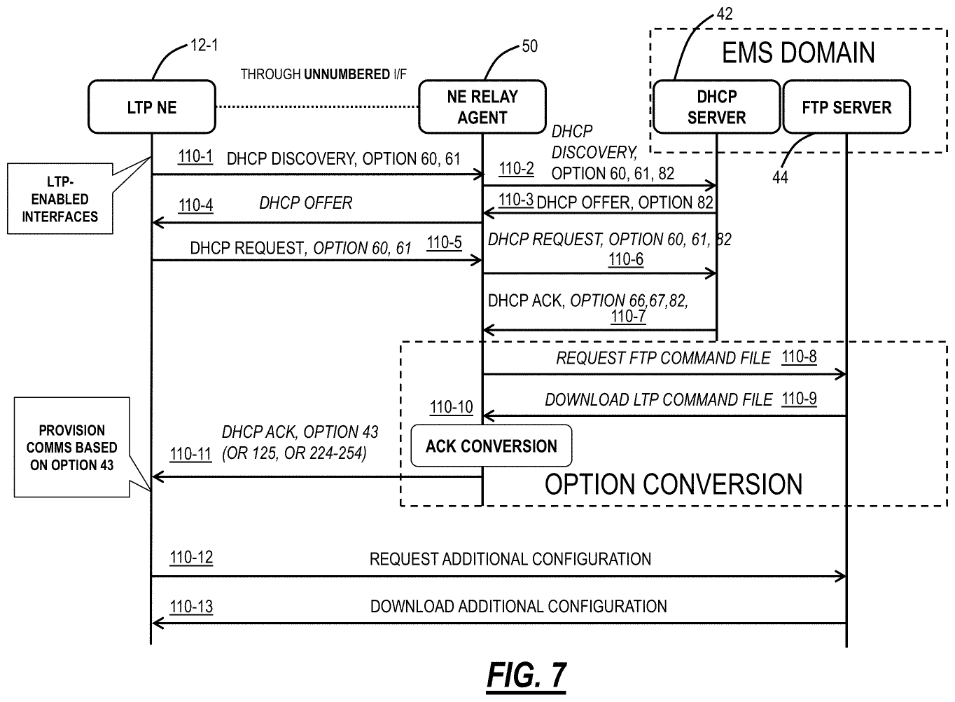

FIG. 7 is a flow diagram of the network element 12-1 connecting to the DHCP Relay Agent 50 through an unnumbered interface with the DHCP Relay Agent 50 performing option conversion. In FIG. 7, the flow is illustrated between the network element 12-1, the DHCP Relay Agent 50, and an EMS domain including the DHCP server 42, and the FTP server 44. Note, the servers 42, 44 can be combined or separate, and other file transfer techniques are contemplated in addition to FTP.

In FIG. 7, the network element 12-1 communicates to the DHCP Relay Agent 50 through an unnumbered interface with LTP/ZTP enabled. Once powered up, the network element 12-1 sends a DHCP discovery, options 60 and 61 to the DHCP Relay Agent 50 (step 110-1). The DHCP Relay Agent 50 sends a subsequent corresponding DHCP discovery with option 82 attached to the DHCP server 42 (step 110-2), and the DHCP server 42 sends back a DHCP offer to the DHCP Relay Agent 50 (step 110-3) which sends the DHCP offer to the network element 12-1 (step 110-4). The network element 12-1 sends a DHCP request to the DHCP Relay Agent 50 (step 110-5) which then sends the DHCP request with options 82 to the DHCP server 42 (step 110-6). The DHCP server 42 sends back a DHCP acknowledgment (ACK) with options 66, 67 to the DHCP Relay Agent 50 (step 110-7).

The DHCP Relay Agent 50 in response to the DHCP ACK sends an FTP request for a configuration file to the FTP server 44 (step 110-8). The FTP server 44 sends the LTP/ZTP configuration file to the DHCP Relay Agent 50 (step 110-9). The DHCP Relay Agent 50 performs an ACK conversion (option conversion) (step 110-10) and sends/forwards the configuration file to the network element 12-1 over the unnumbered interface using a DHCP ACK with option 43 (or 125, or 224-254) with the configuration file therein (step 110-11). Once the network element 12-1 receives the configuration file, LTP/ZTP provisioning occurs, and the network element 12-1 can now reach the FTP server 44, request additional configuration from the FTP server 44 (step 110-12) and receive the additional configuration (step 110-13). Here, in FIG. 7, the IP address, netmask and default routes assigned by the DHCP server 42 are ignored, and the DHCP server does not configure option 43. In FIG. 7, the relay agent 50 optionally can verify whether the configuration file exists locally before it requests an FTP download of the file from the FTP server 44. If the configuration file has been downloaded locally before, the relay agent 50 does not need to re-download the file from the FTP server 44. Instead, it uses the local copy for option conversion. The local copy is kept for a period of time and then deleted from the local system. It is noted that the time that it takes for the relay agent 50 to download the configuration file may be long enough to cause the DHCP client 12-1 to time out. In this case, the LTP/ZTP NE 12-1 will reinitiate the LTP/ZTP process.

### LTP/ZTP Process by the Network Element

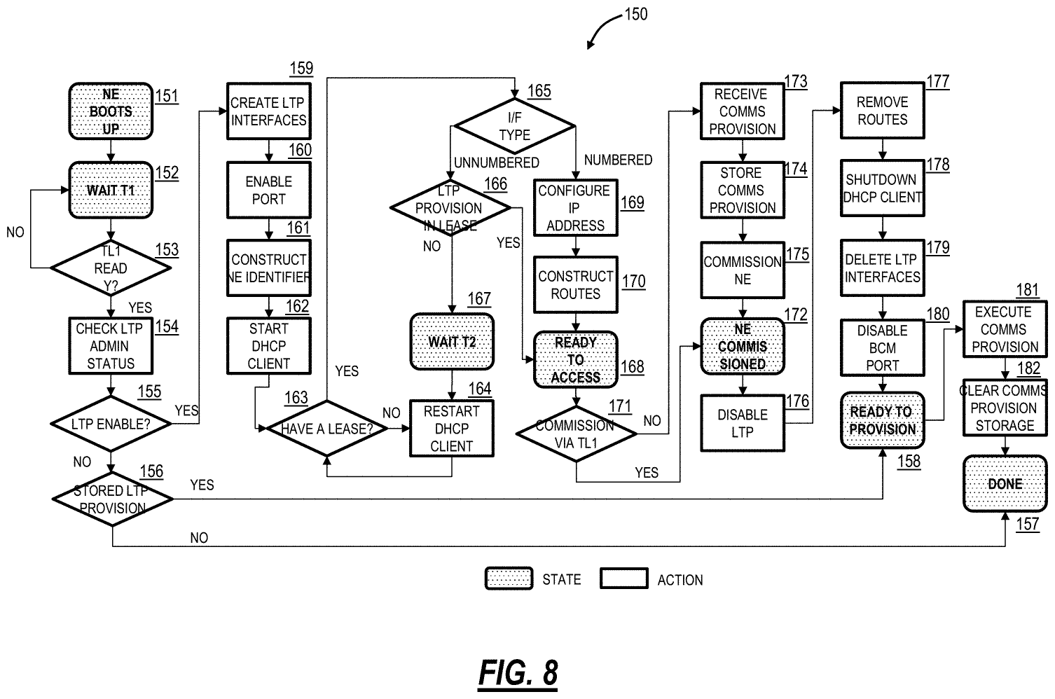

FIG. 8 is a flowchart of an LTP/ZTP process 150 performed by the network element 12-1. The network element 12-1 boots up (step 151), waits for a predetermined time (T1) (step 152) until T1 is ready (step 153). The process 150 includes checking the LTP (or ZTP) administrative status (step 154) to determine if LTP/ZTP is enabled (step 155). If LTP/ZTP is not enabled, the process 150 checks if LTP/ZTP provisioning information is stored (step 156), and if not, the process 150 ends (step 157), however, if LTP/ZTP provisioning information is stored (step 156), the process 150 is ready to provision the network element 12-1 (step 158).

If LTP/ZTP is enabled (step 155), the process 150 includes creating LTP/ZTP interfaces (step 159), enabling the port (step 160), constructing a network element identifier (step 161), and starting a DHCP client 98 (step 162). The BROADCAST flag must be set for the DHCP packets sent by the DHCP client 98 (step 162). The process 150 includes determining if the DHCP client 98 has a lease (step 163) and, if not, restarting the DHCP client 98 (step 164). Once the DHCP client 98 has a lease (step 163), the process 150 is different based on whether the interface is numbered or unnumbered (step 165).

If the interface is unnumbered, the process 150 checks if the LTP/ZTP provisioning information is in the option 43 of the lease (step 166), and, if not, the process 150 includes waiting another predetermined time (T2) and restarting the DHCP client 98 (step 164). If the LTP/ZTP provisioning information is in the lease, the process 150 is ready to access the FTP server 44 (step 168).

If the interface is numbered (step 165), the process 150 includes configuring the IP address and netmask (step 169), constructing routes (step 170), and the process 150 is ready to access the FTP server 44 (step 168). The process 150 checks if the network element 12-1 can be configured via TL-1 (step 171), and, if so, the network element is commissioned (step 172). If the network element 12-1 cannot be configured via TL-1 (step 171), the network element 12-1 receives communications for provisioning (step 173), stores the provisioning information (step 174), and commissions the network element 12-1 (step 175).

After the network element 12-1 is commissioned (step 172), LTP/ZTP is disabled (step 176), routes are removed (step 177), the DHCP client 98 is shutdown (step 178), LTP/ZTP interfaces including IP addresses are deleted (step 179), the port is disabled (step 180), and the network element 12-1 is ready to provision (step 158). Once ready to provision, the process 150 includes executing provisioning (step 181) in terms of the stored provisioning information (step 174) and clearing the stored provisioning information (step 182).

The LTP/ZTP can be enabled by default when the network element 12-1 is manufactured. After the network element 12-1 boots up, the LTP/ZTP can be disabled if the network element 12-1 is commissioned. A type/category of the network element 12-1 can be provided by DHCP option 60, and a unique client identifier can be provided via option 61. For example, the unique client identifier can be a serial number.

For unnumbered interfaces, the DHCP client 98 can process the lease as follows: the IP address and netmask is not configured on the interface; option 3 is ignored, and no default routes are installed into the routing table; option 33 is ignored, and no static routes are installed into the routing table; if Vendor Specific Information (option 43) is present in the lease, the DHCP client follows instructions embedded in the option to provision the NE; otherwise, the DHCP client rejects the lease, waits for a while, and starts the DHCP negotiation process again.

### DHCP Relay Agent

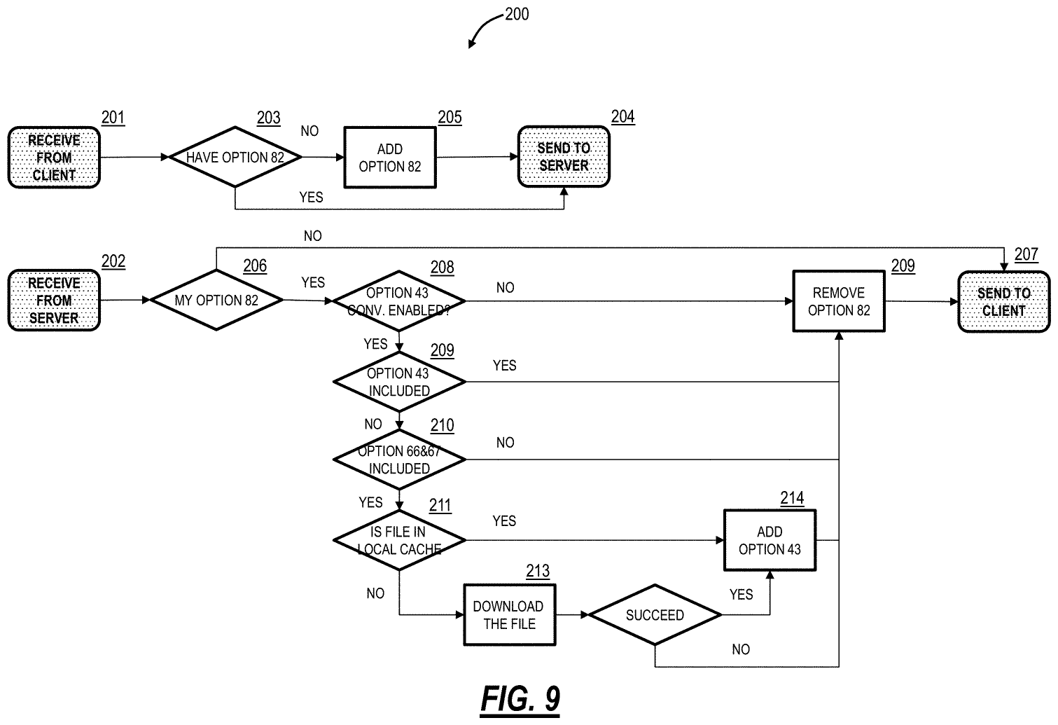

FIG. 9 is a flowchart of a DHCP Relay Agent process 200. The DHCP Relay Agent 50 can be either of the DHCP Relay Agents 50A, 50B. The DHCP Relay Agent 50 is enabled on an interface connecting to the network element 12-1. Option conversion can be automatically enabled if the interface is unnumbered; otherwise, it is disabled. The process 200 operates based on whether the DHCP Relay Agent receives DHCP packets from the DHCP client (step 201) or from the DHCP server 42 (step 202). When packets are received from the DHCP client (step 201), the process 200 checks if the data includes option 82 (step 203), and, if so, the process 200 includes forwarding the packets to the DHCP server 42 (step 204), and, if not, the process 200 includes adding option 82 (step 205).

When a response packet is received from the DHCP server 42 (step 202), the process 200 includes checking if option 82 is used for the DHCP Relay Agent 50 (step 206), and, if not, the process 200 includes forwarding the packet to the DHCP client (step 207). If the data is set to option 82 of the DHCP Relay Agent 50 (step 206), the process 200 includes checking if option conversion is enabled (step 208), and, if not, the process 200 includes removing the option 82 (step 209) and forwarding the response packet to the client (step 207). If the option conversion is enabled (step 208), the process 200 includes checking if option 43 is included, and if so, the process 200 includes removing the option 82 (step 209) before sending to the client (step 207). If option 43 is not included (step 209), the process 200 includes checking if options 66, 67 are included (step 210), and, if not, the process 200 includes removing the option 82 (step 209) and sending to the client (step 207). If options 66, 67 are included (step 210), the process 200 includes checking if the configuration file is in a local cache (step 211), and, if so, adds option 43 (step 212) and sends the configuration file. If the configuration file is not in a local cache (step 211), the process 200 includes downloading the configuration file (step 213).

The DHCP Relay Agent 50 is configured to download the configuration file on behalf of the network element 12-1, i.e., the DHCP client. The file can be stored locally on the network element 12-1 running the DHCP Relay Agent 50. The life cycle of the file can be managed (e.g., the file may be removed after 30 minutes).

Although the diagram shows that option 43 is used for conversion, it is noted that other options can also be employed such as options among 224-254 or option 125.

### DHCP Server

The DHCP server 42 is configured to provide the following two configuration options: Option 1: Use Client Identifier to identify a configuration; and Option 2: Use Relay Agent Information Option (option 82) to identify a configuration. For Option 1, the DHCP server 42 or northbound application obtains knowledge of the identity of the individual network element and associates the client identifier with a particular configuration. A manual intervention (a.k.a. “touch”) is employed to make the above association. The client identifier becomes the “key” to identify the individual configuration. For Option 2, the DHCP Relay Agent 50 provides its own identity (not necessary the Client Identifier) as well as local circuit information to assist the DHCP server 42 or northbound application to identify a configuration for the network element 12. The information determines the location of the network element 12 and the configuration in terms of the location without manual intervention.

### LTP/ZTP Over Numbered Interfaces

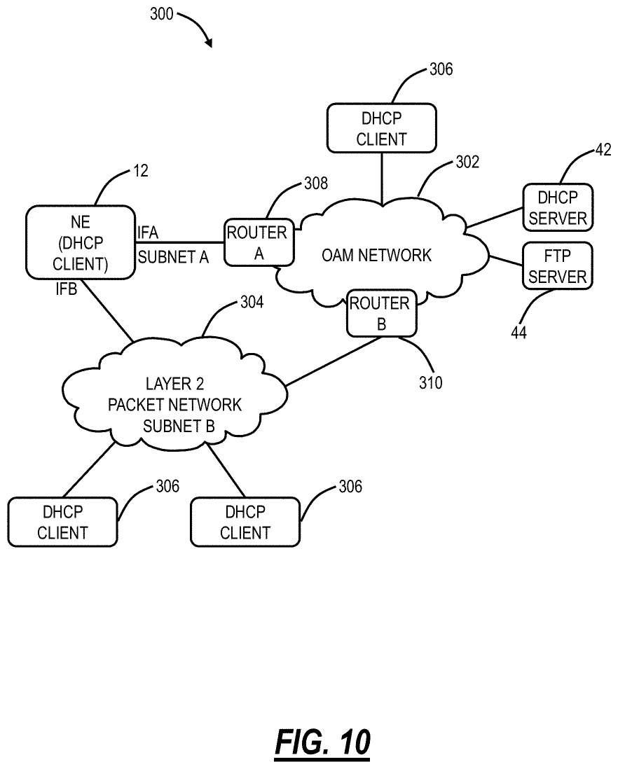

FIG. 10 is a network diagram of a network 300 with a network element 12 with multiple numbered interfaces communicating to a single DHCP server 42. The network 300 includes an OAM network 302, a layer 2 packet transport network 304, DHCP clients 306, and routers A, B 308, 310. The network element 12 can have two types of interfaces (IFA, IFB)—those connecting to Data Communication Networks (DCN) for Operations, Administration, and Maintenance (OAM) purpose (herein referred to as the OAM network 302) and those connecting to the layer 2 packet transport network 304. The network element 12 can employ Zero Touch Provisioning (ZTP) through both types of interfaces. In FIG. 6, the LAN interfaces 92 and the optical line interfaces 90 can participate in the OAM network 302 while the Layer-2 packet interface modules 80 can participate in the layer 2 packet network 304.

As described herein, the operator configures the DHCP server 42 and the FTP server 44 for ZTP purposes. The DHCP server 42 has been configured in such a way that each device configuration has an associated unique identifier indicated by the DHCP client identifier in the DHCP packets. The client identifier can be the serial number of the device (network element 12). The interface IFA connects to the OAM network 302 while the interface IFB participates in the layer 2 packet network 304. Both interfaces are numbered interfaces meaning an IP address is employed for the interface to communicate. The IP subnet assigned to IFA and IFB must be different (i.e., not overlapping) in order to allow IP forwarding to find the proper next hop. For illustration purposes, assume the IFA is connecting to IP subnet A and the IFB connecting to IP subnet B.

Without knowing the topology after boot up, the network element 12 has to run DHCP clients 98 on both IFA and IFB. DHCP client 98 instances on the network element 12 send DHCP packets out IFA and IFB and waits for a DHCP response which specifies the interface IP address and location of the configuration file from the DHCP server 42. When the DHCP server 42 receives the DHCP packets from the network element 12, it cannot distinguish whether they are sent via IFA or IFB because the IP address assignment and configuration correlation is based on the unique identifier of the network element 12 which is the same. Assume the DHCP server 42 is configured to associate subnet B to the network element 12. Then the DHCP server 42 assigns the subnet B in a response to the DHCP requests from the network element 12. If the DHCP requests sent via IFA get the response earlier than IFB, the subnet B is assigned to the IFA instead of the IFB. Essentially once the subnet B is configured to the IFA, it can no longer be assigned to the IFB. Now when the network element 12 attempts to contact the FTP server 44 for its configuration, the operation cannot succeed because the subnet configured on the IFA does not match the subnet configured on the router A 308. Consequently, the network element 12 is not able to be provisioned and is not able to be accessed remotely.

The systems and methods resolve this problem in such a way that the DHCP clients 98 on the network element 12 automatically determine and apply the IP assignment to the proper interface IFA, IBA. Generally, when the DHCP client receives a lease from a numbered interface, instead of configuring the interface immediately, it determines which interface the IP assignment (including IP address, netmask, and default route) the lease should be applied to. In order to achieve that, the network element 12 uses Address Resolution Protocol (ARP) to probe the gateway (obtained from the lease) on each numbered interface to determine whether the interface connects to the specified gateway (in this example, the routers A, B 308, 310). Then the network element 12 performs a check on the assigned address to ensure that the address is not already in use. Once an interface is identified by the above procedure, the IP address is applied to the interface even if it is different from the interface on which the lease is received (such as is the case described above).

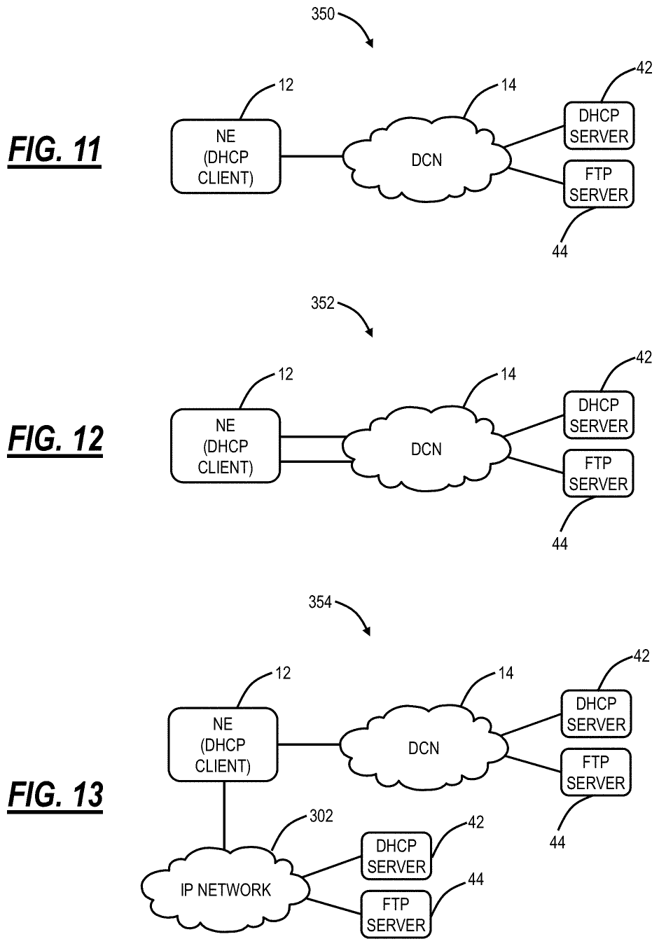

FIG. 11 is a network diagram of a network 350 for zero touch provisioning over a numbered interface with a single DHCP server 42 and FTP server 44. FIG. 12 is a network diagram of a network 352 for zero touch provisioning over multiple numbered interfaces with a single DHCP server 42 and FTP server 44. FIG. 13 is a network diagram of a network 354 for zero touch provisioning over multiple numbered interfaces with multiple DHCP servers 42 and FTP servers 44.

Again, ZTP or LTP allows the network element 12 to be provided and configured automatically. In FIG. 11, the network element 12 sends out a request through DHCP to the DHCP server 42 to obtain the location of its configuration (the FTP server 44). Then the network element 12 downloads the configuration and installs it.

With respect to multiple interfaces, there are several approaches to deploying ZTP. In FIG. 12, the network element 12 has two numbered interfaces connected to the DCN 14. A first approach uses a single DHCP server 42. When the DHCP server 42 receives the DHCP request from the network element 12, there are three approaches to determine a configuration specific to the network element 12 that sends out the DHCP request.

First, a unique client identifier of the network element 12 can be mapped to a configuration. Since each network element 12 has a unique identifier such as a serial number which can be used as the client identifier, the DHCP server 42 is able to identify the network element 12 and assign the specific configuration to it. However, this is restricted to a single numbered ZTP interface supported per network element 12, which is not always the case as in FIG. 12.

Second, the interface Media Access Control (MAC) address of the network element 12 can be mapped to a configuration. If the MAC address is unique per physical port interface, the DHCP server 42 is able to assign the specific configuration to the network element 12. For vendors that have a single MAC address per network element 12 (all interfaces share the same MAC), this is equivalent to the first approach above. For vendors that have a unique MAC per interface, this approach is able to overcome the challenge of multiple interfaces. However, practically, this approach is rarely used because it could be a large logistic effort to collect and manage all interface MAC addresses for all network elements, especially in larger networks.

Third, option 82 in DHCP request can be used and added by DHCP relay agents 50 to map to a configuration. The option 82 data can contain the identity of the DHCP relay agent 50 as well as the local port of the DHCP relay agent 50 connecting to the network element 12, which can be used to identify the device 12 as long as the link to the relay agent 50 is point-to-point, star network topology, etc. However, the numbered interface can be employed to connect to a layer 2 packet network 304 causing this approach to fail. In general, this approach does not apply as long as one of the ZTP interfaces connects to the layer 2 packet network 304.

In FIG. 13, another approach uses multiple DHCP servers 42, one for each subnet. In this approach, a dedicated DHCP server 42 is employed for each IP network that the interface participates in. Therefore, a different IP address can be assigned to each numbered interface of the network element 12 independently.

### LTP/ZTP Over Multiple Numbered Interfaces

The systems and methods allow ZTP to be enabled on multiple numbered interfaces per network element 12, which overcomes the restriction of a single numbered ZTP interface per device 12. Meanwhile, the systems and methods use a unique identifier per network element 12 instead of MAC address per interface to identify the specific configuration of the network element 12, which addresses the logistic concern of managing the MAC addresses, the performance of the DHCP server 42 and scalability. Furthermore, the systems and methods apply as well to configurations with the layer 2 packet network 304. The systems and methods do not require multiple DHCP servers 42, which simplifies the server/network management.

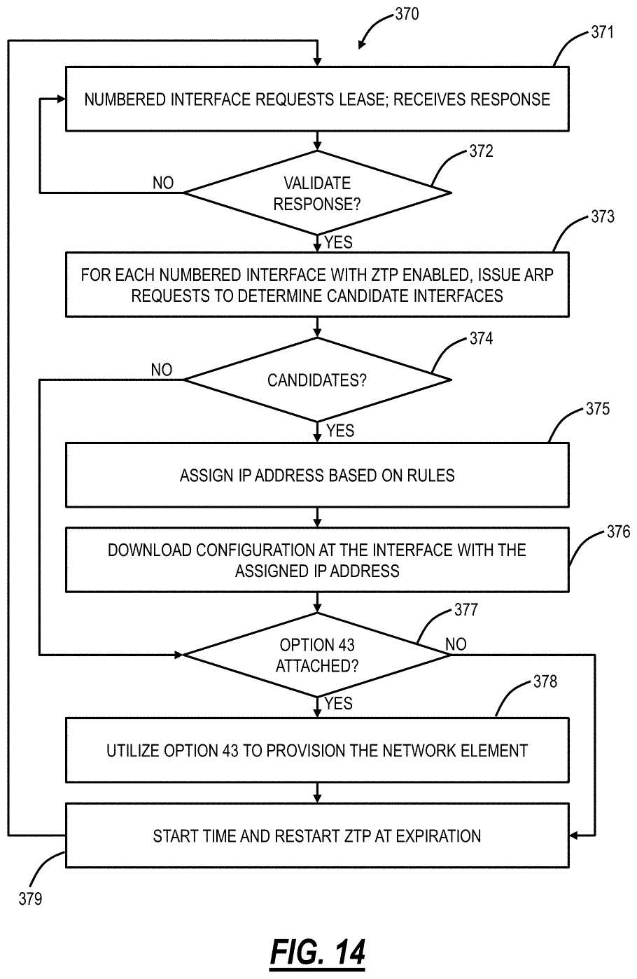

FIG. 14 is a flowchart of a process 370 for zero touch provisioning of a network element having multiple numbered interfaces. A numbered interface on which ZTP is enabled requests a lease (DHCP request) and when a valid lease is received on the numbered interface (step 371), the IP address, netmask, and gateway are not immediately applied to the numbered interface. Instead, the process 370 checks to validate the response (step 372).

For validation, the network element checks that the IP address and gateway are unicast addresses, the netmask is non-zero, and the gateway is a unicast address and is part of the assigned IP subnet. If any fail, the lease is rejected and the ZTP is restarted on the numbered interface (step 371). Further, for the validation, if the IP address has already been configured on another numbered interface, the lease is rejected, and the ZTP is restarted on the numbered interface (step 371).

For each numbered interface with ZTP enabled, ARP requests are issued to determine candidate interfaces (step 374). On each numbered interface where the ZTP is enabled, and the IP address has not been assigned, step 374 can include:

A) The network element issues ARP requests for the gateway address to the numbered interface (Gateway detection). By doing so, the network element 12 fills in its own hardware address as the sender's hardware address, and 0 as the sender's IP address, to avoid confusing ARP caches in other hosts on the same subnet.

B) If an ARP response is received on the numbered interface, go to step C) because it means that the gateway connects to the numbered interface; otherwise, loop to the next numbered interface.

C) The network element issues ARP requests for the assigned IP address to the numbered interface (duplicate address detection). By doing so, the network element must fill in its own hardware address as the sender's hardware address, and 0 as the sender's IP address, to avoid confusing ARP caches in other hosts on the same subnet.

D) If an ARP response is not received on the numbered interface, mark the numbered interface as a candidate because it means that no duplicate IP address is detected on the subnet.

E) loop to the next numbered interface (if any).

If there are candidate interfaces (step 374), the IP assignment can be applied to one of them based on rules (step 375). The rules include—if the numbered interface on which the DHCP response is received is a candidate, the IP assignment can be applied to it. Otherwise, all other interfaces have an equal preference, and one of them can be picked arbitrarily. The process 370 includes downloading the configuration at the numbered interface with the assigned IP address (step 376).

Otherwise, there is no candidate interface (step 374). In this case, the process 370 includes determining whether the option 43 is attached to the lease (DHCP response) and can be used for configuration (step 377). If so, the network element utilizes the configuration in option 43 to provision the network element (step 378). Otherwise, a timer is started, the lease is rejected, and ZTP will be restarted on the numbered interface at timer expiration (step 379).

### NAT Gateway

One problem with ZTP or LTP is when the configuration server with the provisioning information for a network element is located in a different network (i.e., different address space). Network Address Translation (NAT) is a technique of mapping one Internet Protocol (IP) address space into another by modifying network address information in the IP header of packets. A NAT gateway is used to segment different private networks such as from the Internet. If the network element is located in a different network than the configuration server and an associated Dynamic Host Configuration Protocol (DHCP) server, DHCP requests from the network element are not able to reach the DHCP server and the configuration server.

There are generally three approaches to address this issue where a NAT gateway is located between the network element and the DHCP server/configuration server. First, the DHCP server can be moved within the private IP address space with the network element so that the DHCP packets do not need to pass through the NAT gateway. Second, a tunneling technique can be used such as Generic Routing Encapsulation (GRE), Virtual Private Network (VPN), etc. to tunnel DHCP packets between a DHCP relay agent and the DHCP server/configuration server. Third, all network elements in the private address space can be connected to the NAT gateway via the same network so a DHCP relay agent on the NAT gateway can serve the DHCP clients directly.

Of course, there are shortcomings with each of the approaches. First, network planners usually divide their network elements into several isolated groups in order to scale. Each group has one or more NAT gateway to communicate with northbound management systems. A network configuration of optical networks may choose to group all of the network elements in a specific site together and the network elements within a domain together. The network elements in a group communicate with the northbound management systems via the NAT gateways of its group. As a result, each group, by employing the first approach, can equip a DHCP server, which dramatically increases deployment cost as a network grows and also increases management complexity because the ZTP boot files that must be distributed to different DHCP servers.

The second approach avoids the shortcomings of the first approach because all DHCP boot files can be managed in a centralized DHCP server residing in the customers' data communication networks (DCN). However, in order to allow the DHCP packets to pass through the NAT gateway, a tunnel must be established between each DHCP relay agent and the DHCP server/configuration server. In zero touch provisioning contexts, it means that the tunnel must be provisioned on nearly every single network element because each remote network element (RNEs) requires a DHCP relay agent in order to complete ZTP. As a result, the tunneling approach not only increases the provisioning and management complexity but also raises security concerns.

The third approach requires a large layer 2 network in the private IP address space. In large optical networks where the network elements are not geographically close, the third approach requires extensive planning and provisioning to bring all the network elements on the same layer 2 network. In a typical optical system, the management traffic is carried over an Optical Service Channel (OSC), General Communication Channel (GCC) in Optical Transport Network (OTN), or Data Communication Channel (DCC) in SONET which do not have layer 2 functionality. Therefore, users have to equip extra layer 2 optical cards and carefully plan to avoid layer 2 traffic loops. Hence, the third approach is complex and costly.

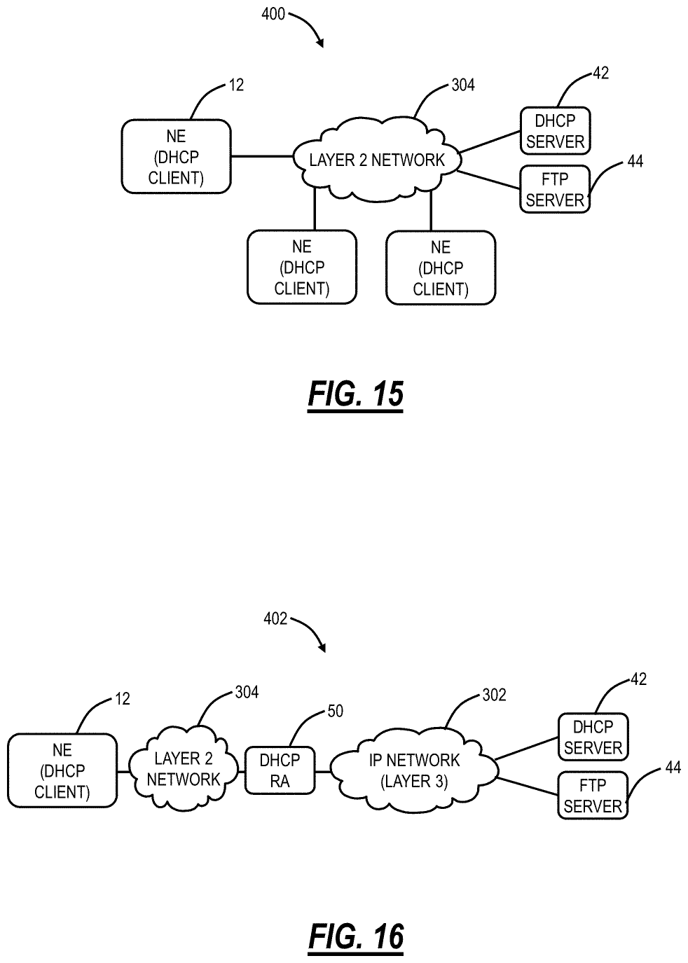

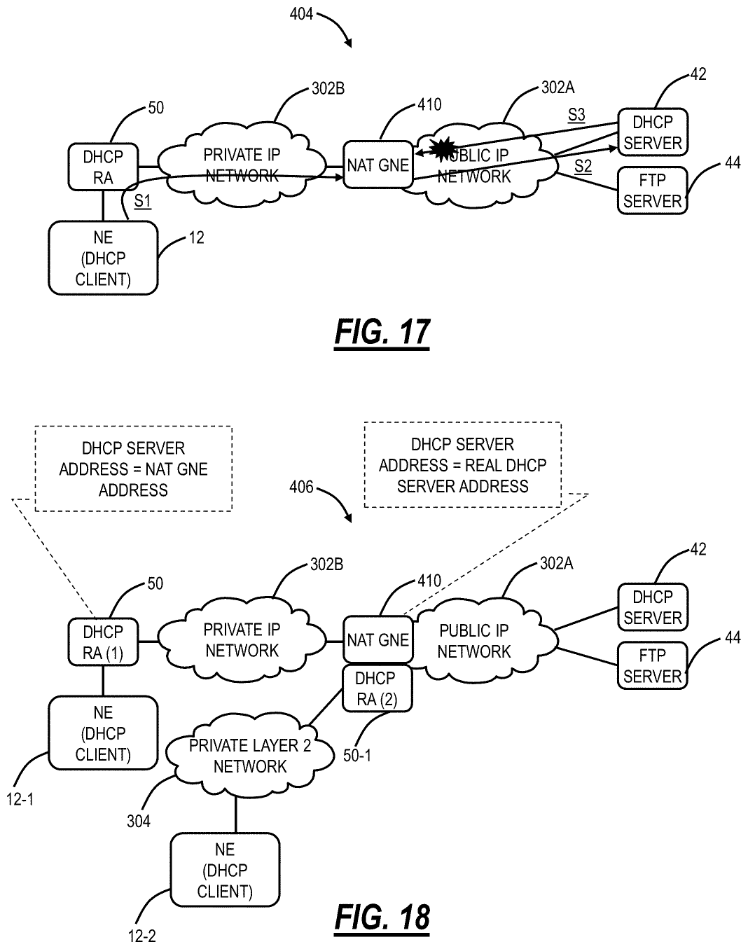

FIG. 15 is a network diagram of a network 400 illustrating zero touch provisioning of network elements 12 over a layer 2 packet network 304. FIG. 16 is a network diagram of a network 402 illustrating zero touch provisioning of network elements 12 over a layer 3 network 302. FIG. 17 is a network diagram of a network 404 illustrating the problems in zero touch provisioning of network elements 12 where a NAT gateway 410 prevents a DHCP Relay Agent 50 from communicating to the DHCP server 42. FIG. 18 is a network diagram of a network 406 illustrating zero touch provisioning of the network elements 12-1, 12-2 through the NAT gateway 410.

In FIG. 15, the DHCP server 42, the FTP server 44, and the network elements 12 are all located on the same layer 2 packet network 304. In this case, the network elements 12 broadcast their DHCP BOOTREQUEST packets on the layer 2 packet network 304 and the DHCP server 42 replies to the network elements 12 by assigning a lease to them so that the network elements 12 are able to complete the ZTP process by communicating to the FTP server 44.

In FIG. 16, however, the DHCP server 42 and the network elements 12 are not in the same layer 2 packet network 304. Therefore, the DHCP BOOTREQUEST packets are not able to reach the DHCP server 42. To resolve this issue, RFC2131 introduces the DHCP Relay Agent (RA) 50 as a mediator to exchange DHCP packets between the DHCP clients (network element 12) and the DHCP server 42. The IP address of the DHCP server 42 can be configured on the DHCP Relay Agent 50. In FIG. 16, the network elements 12 broadcast their DHCP BOOTREQUEST packets within the layer 2 packet network 304. In this case, the DHCP BOOTREQUEST packets can arrive at a neighbor network element 12-1 which is provisioned as a DHCP Relay Agent 50. The DHCP Relay Agent 50 then converts the received broadcast packets to unicast packets and sends them to the DHCP server 42 over the layer 3 network 302. When the DHCP server 42 receives the packets, it unicasts the DHCP BOOTREPLY packets back to the DHCP Relay Agent 50, and the packets are forwarded unicast to the network element 12.

In FIG. 17, Network address translation (NAT) is a process of remapping a private IP address space into a public IP address space by modifying IP and/or port information of the IP packets while they are in transit across a NAT Gateway Network Element (GNE) 410. For example, in FIG. 17, the network 404 includes a public IP network 302A and a private IP network 302B with the NAT gateway 410 in between. Specifically, when the NAT gateway 410 receives a UDP packet destined to a public IP address from the private IP address space, it modifies the source IP address of the packet to its own public IP address and the source UDP port to a newly assigned UDP port. The NAT gateway 410 then tracks the mapping between the new port and the combination of the private IP address and port for returning packets. The returning packets must use the source IP address (i.e., the NAT gateway 410 address) and source port (i.e., the new port) of the original packets as the destination IP address and destination port of the returning packets. When the NAT gateway 410 receives the reply packets, it attempts to match the destination port of the packet to a combination of the private IP address and UDP port. If a match is found, the NAT gateway 410 modifies the destination IP to the private IP address, and the destination port to the tracked address corresponding to the original UDP packet and forwards the packet to that private network destination.

In FIG. 17, the NAT gateway 410 prevents the DHCP Relay Agent 50 from communicating to the DHCP server 42. The issue comes from the DHCP standard RFC2131. The standard requires DHCP clients to send BOOTREQUEST packets to the UDP port 67 of the DHCP servers 42. It also requires DHCP servers 42 to send BOOTREPLY packets to the UDP port 67 of the DHCP Relay Agents 50 or port 68 of the DHCP clients. RFC2131 also requires DHCP servers 42 to use the IP address of the DHCP Relay Agent 50 (in private IP address space) as the destination IP address of the returning packets instead of the source IP address of the receiving packets (in public IP address space). The above requirements create the problem that the returning packets cannot be routed to the DHCP Relay Agent 50 in the public IP networks because the destination IP address is in private IP space.

Details of this problem are as follows with reference to FIG. 17. At step S1, when the DHCP client at the network element 12 initiates DHCP negotiation, it broadcasts a DHCP BOOTREQUEST packet. When the packet arrives at the DHCP Relay Agent 50, the DHCP Relay Agent 50 sets its private IP address to the DHCP packet as NAT gateway 410 address and forwards it to the DHCP server 42.

At step S2, when the packet arrives at the NAT gateway 410, the source IP address of the packet is translated to the public address of the NAT gateway 410 and the source UDP port is translated to a newly assigned UDP port. The NAT gateway 410 then forwards the packet to the DHCP server 42. At step S3, when the DHCP server 42 receives the packet, it responds by sending a DHCP BOOTREPLY packet to the port 67 of the NAT gateway 410 address specified in the received DHCP packet. Since the NAT gateway 410 address is in the private IP address space, the BOOTREPLY packet cannot be routed to the NAT gateway 410, causing the DHCP negotiation to fail.

RFC3011 and RFC3527, the contents of which are incorporated by reference herein, define additional DHCP options so that the DHCP server 42 can send BOOTREPLY packets to an IP address different from the NAT gateway 410 address. By using these options, the DHCP Relay Agent 50 can instruct the DHCP server 42 to send the BOOTREPLY packets to the public IP address of the NAT gateway 410. With this arrangement, the DHCP BOOTREPLY packets can arrive at the NAT gateway 410. However, the NAT gateway 410 does not forward the packets to the DHCP Relay Agent 50 because the destination port is not the newly assigned UDP port but the port 67. Therefore, the NAT gateway 410 is not able to map the packets to a private network destination.

### ZTP/LTP Through NAT Gateway

The systems and methods allow DHCP packets to be exchanged in the NAT gateway 410 network configuration, enabling ZTP in such deployment. In FIG. 18, the systems and methods include a network configuration with a special DHCP Relay Agent 50-1 configured at the NAT gateway 410 and techniques implemented in the special DHCP Relay Agent 50-1 on the NAT gateway 410. The DHCP Relay Agent 50-1 not only performs standard DHCP relay functions to serve any DHCP clients (e.g., the network element 12-2 that connect to it via the layer 2 packet network 304), but also serves other DHCP clients (e.g., the network element 12-1) via the DHCP Relay Agent 50.

Unlike the standard DHCP deployment where the DHCP server 42 address must be provisioned on the DHCP Relay Agent 50 to unicast the packets to the DHCP server 42, in accordance with the systems and methods, the IP address of the NAT gateway 410 to be provisioned on the DHCP Relay Agent 50, i.e., the “DHCP server address” for the DHCP Relay Agent 50 is set to the NAT gateway address 410, not the DHCP server 42 address. The IP address of the DHCP server 42 must be provisioned on the DHCP Relay Agent 50-1. The DHCP Relay Agent 50-1 can serve multiple DHCP Relay Agents 50 as well as multiple layer 2 DHCP clients, such as the network element 12-2.

Specifically, the network configuration of the network 406 has all DHCP packets in the private IP network 302B and the layer 2 packet network 304 destined to the DHCP Relay Agent 50-1 on the NAT gateway 410, including the DHCP packets forwarded by the DHCP Relay Agent 50. When the DHCP Relay Agent 50-1 identifies that the DHCP packets come from the DHCP Relay Agent 50, it performs option 82 switching and relays the packets to the DHCP server 42. The DHCP server 42, without noticing the existence of the DHCP Relay Agent 50, sends the DHCP packets back to the DHCP Relay Agent 50-1 which performs the option 82 switching and forwards the packets to the DHCP Relay Agent 50. Therefore, DHCP bidirectional communication is established between the DHCP Relay Agent 50 and the DHCP server 42. When the DHCP Relay Agent 50-1 identifies that the DHCP packets come from the DHCP clients (e.g., the network element 12-2) directly via the layer 2 packet network 304, it performs the standard DHCP relay functionality.

### Option 82 Switching

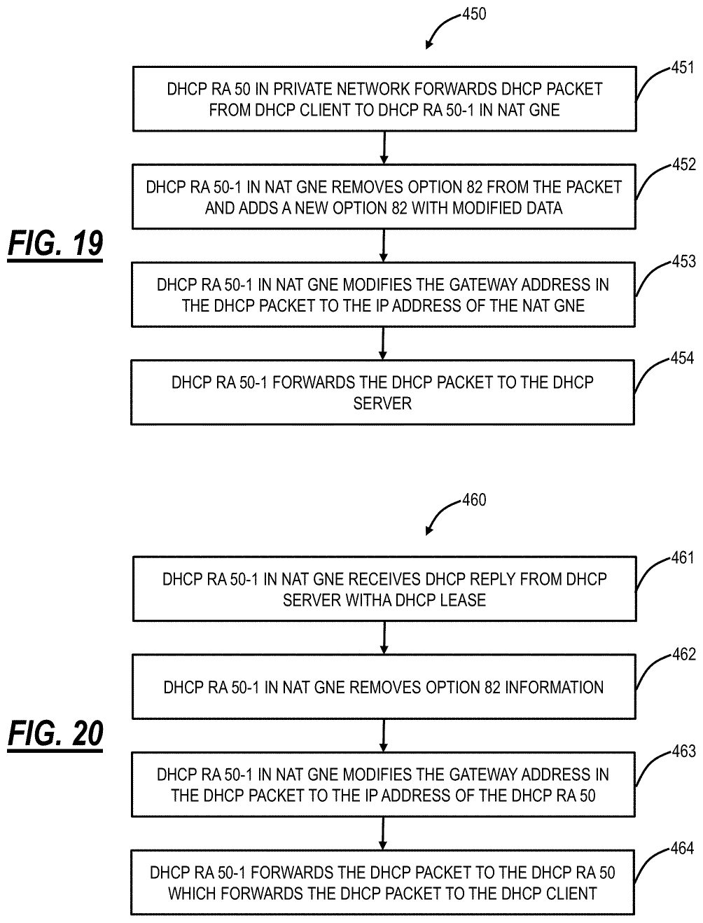

FIG. 19 is a flowchart of a process 450 for sending a DHCP packet from a DHCP client in the network element 12-1 to the DHCP server 42 through the NAT gateway 410. FIG. 20 is a flowchart of a process 460 for sending a DHCP packet from the DHCP server 42 to the DHCP client in the network element 12-1 through the NAT gateway 410. Specifically, the processes 450, 460 describe so-called option 82 switching, namely the DHCP Relay Agent 50-1 performs relay agent information option switching when the DHCP Relay Agent 50-1 receives DHCP packets from the DHCP Relay Agent 50 destined to the DHCP server 42 and vice versa.

In FIG. 19, the process 450 is implemented responsive to the DHCP client in the network element 12-1 sending a DHCP packet (e.g., DHCP BOOTREQUEST) to the DHCP Relay Agent 50 destined to the DHCP server 42. The DHCP Relay Agent 50 forwards the DHCP packet from the DHCP client in the network element 12-1 to the DHCP Relay Agent 50-1 (step 451). The DHCP Relay Agent 50-1 then removes the option 82 from the packet and adds a new option 82 that contains the sub-options of the original option 82 as well as a Link Selection Sub-option and a Vendor-Specific Information Sub-option (step 452). The Link Selection Sub-option contains the original gateway address which is the IP address of the DHCP Relay Agent 50. The gateway address is then modified to the public IP address of the NAT gateway 410 (step 453). As an option, a signature is generated and set to the Vendor-Specific Information Sub-option for authentication of the returning packets. After the option 82 switching, the DHCP Relay Agent 50-1 forwards the packet to the DHCP server 42 (step 454).

When the DHCP server 42 receives the DHCP BOOTREQUEST packet, it must assign a DHCP lease associated with an IP address pool. In terms of RFC3527, the DHCP server 42 first looks at the Link Selection Sub-option of the option 82 and uses that address to pick the IP address pool. Since that sub-option contains the IP address of the DHCP Relay Agent 50, the DHCP server 42 essentially uses that address to select the pool, which is expected by the DHCP Relay Agent 50. Then the DHCP server 42 sends a reply packet (e.g., BOOTREPLY) to the port 67 of the public IP address of the DHCP Relay Agent 50-1. By applying the option 82 switching technique on the DHCP Relay Agent 50-1, a standard DHCP server 42 is able to select correct leases for the DHCP clients and send them to the DHCP Relay Agent 50-1 successfully.

In FIG. 20, when the DHCP Relay Agent 50-1 on the NAT gateway 410 receives the DHCP BOOTREPLY packet from the DHCP server 42 (step 461), it removes the Link Selection Sub-option and Vendor-Specific Information Sub-option from the option 82 (step 462), restores the gateway address to the DHCP Relay Agent 50 (step 463), and forwards the packet to the DHCP Relay Agent 50 (step 464). Since the DHCP Relay Agent 50 performs standard DHCP relay functions, the packets are then forwarded to the DHCP clients. The DHCP packets travel successfully between the DHCP client in the network element 12-1 and the DHCP server 42 on the NAT GNE network configuration. Therefore, the ZTP can be realized in such network deployments.

The following table illustrates the option 82 switching at the DHCP Relay Agent 50-1 for different packet directions between the DHCP Relay Agent 50 and the DHCP Relay Agent 50-1, between the DHCP Relay Agent 50-1 and the DHCP server 42, between the DHCP server 42 and the DHCP Relay Agent 50-1, and between the DHCP Relay Agent 50-1 and the DHCP Relay Agent 50. Of note, the DHCP Relay Agent 50-1 is a node in each of these transactions and is configured to perform option 82 switching where the data in option 82 is modified to enable exchange between the DHCP client in the network element 12-1 and the DHCP server 42. GIADDR stands for Gateway IP Address.

| | | | Vendor-Specific | |
|---|---|---|---|---|
| | | Link Selection | Information | Destination IP |
| Packet Direction | GIADDR | Sub-option | Sub-option | Address |
| DHCP RA 50 → | Private IP | X | X | DHCP RA 50-1 |
| DHCP RA 50-1 | address of | | | |
| | DHCP RA 50 | | | |
| DHCP RA 50-1 → | NAT GNE | Private IP | Signature | DHCP Server 42 |
| DHCP Server 42 | Public IP | address of | | |
| | Address | DHCP RA 50 | | |
| DHCP Server 42 → | NAT GNE | Private IP | Signature | GIADDR (NAT |
| DHCP RA 50-1 | Public IP | address of | | GNE Public IP |
| | Address | DHCP RA 50 | | Address) |
| DHCP RA 50-1 → | Private IP | X | X | GIADDR (Private IP |
| DHCP RA 50 | address of | | | address of DHCP |
| | DHCP RA 50 | | | RA 50) |

DHCP Relay Agent process

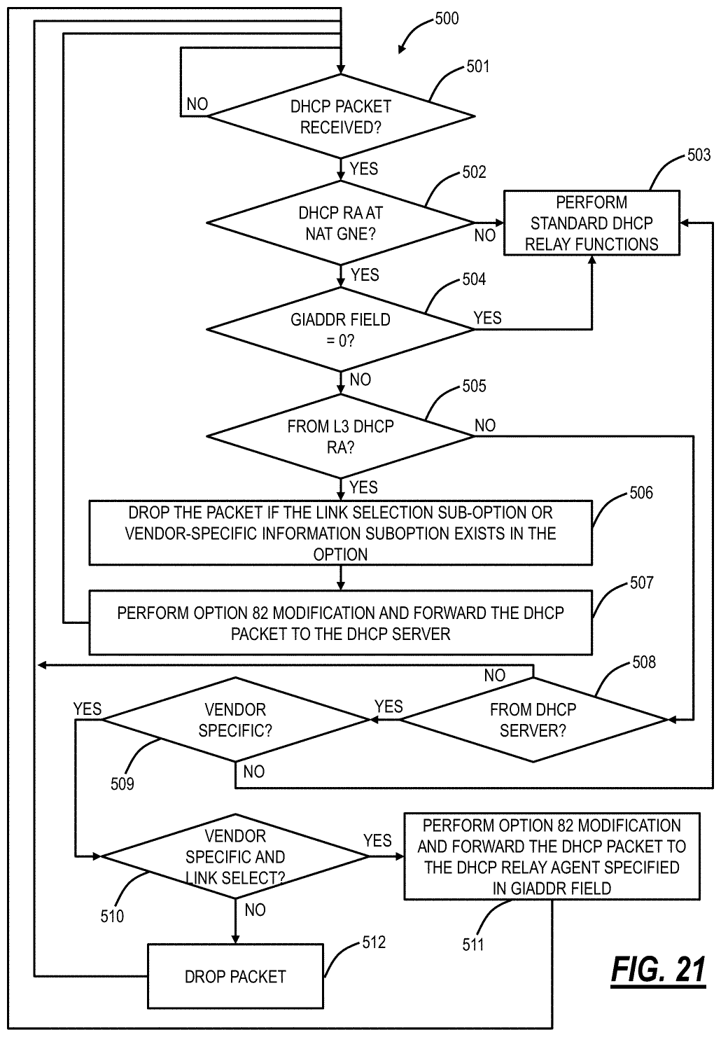

FIG. 21 is a flowchart of a process 500 implemented by a DHCP Relay Agent (generic network element 12-1), such as the DHCP Relay Agent 50, DHCP Relay Agent 50-1. When DHCP packets are received on the DHCP Relay Agent (step 501), the process 500 includes, if the DHCP Relay Agent is not at a NAT GNE (step 502), performing standard DHCP relay functions such as defined in RFC2131 (step 503). If the DHCP Relay Agent is at the NAT GNE (step 502) and the GIADDR field is zero (step 504), the process 500 includes performing standard DHCP relay functions such as defined in RFC2131 (step 503).

If the GIADDR field is not zero (step 504), and the DHCP packet is from a Layer 3 DHCP Relay Agent (step 505), the process 500 includes dropping the packet if the Link Selection Sub-option or Vendor-Specific Information Sub-option exists in the option 82 (step 506) and performing option 82 modification and forwarding the DHCP packet to the DHCP server (step 507). The option 82 modification can include removing the existing option 82 data from the DHCP packet or if it does not exist, creating new option 82 data; adding the Link Selection Sub-option to the option 82 with the value of the sub-option as the value of the GIADDR field; adding the Vendor-Specific Information Sub-option to the option 82 with the value of the sub-option as a signature that is used to validate the returning packets from the DHCP server; setting the public IP address of the NAT GNE to the GIADDR field; and adding the option 82 data back to the DHCP packet.

If the DHCP packet is not from a Layer 3 DHCP Relay Agent (step 505) and from a DHCP server (step 508) and if Vendor-Specific Information Sub-option does not exist (step 509), standard DHCP relay functions are performed such as defined in the RFC2131 (step 503).

If both the Link Selection Sub-option exists and Vendor-Specific Information Sub-option exist (step 510), then option 82 modification is performed, and the DHCP packet is forwarded to the DHCP Relay Agent specified in the GIADDR field (step 511). If both the Link Selection Sub-option and Vendor-Specific Information Sub-option do not exist (step 510), the DHCP packet is dropped (step 512). The option 82 modification in step 511 can include optionally validating the signature in the Vendor-Specific Information Sub-option to ensure the BOOTREPLY packet to be the one responding to the BOOTREQUEST packet initiated by the NAT GNE and to drop the packet if the validation fails; setting the value of the Link Selection Sub-option to the GIADDR field; and removing both sub-options from the option 82.

### Process of LTP/ZTP Through a NAT Gateway

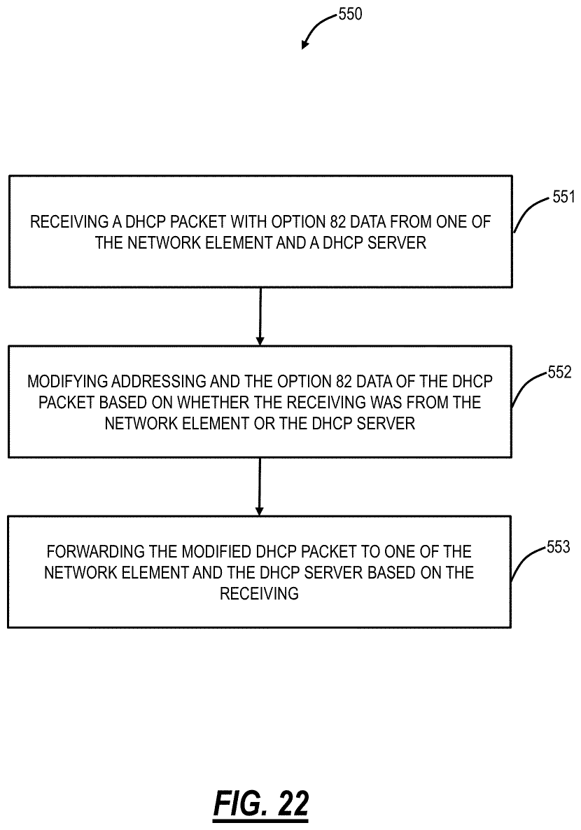

FIG. 22 is a flowchart of a process 550 of low or zero touch provisioning of a network element through a Network Address Translation (NAT) gateway, implemented via a first Dynamic Host Configuration Protocol (DHCP) Relay Agent operating at the NAT gateway. The process 550 includes receiving a DHCP packet with option 82 data from one of the network element and a DHCP server (step 551); modifying addressing and the option 82 data of the DHCP packet based on whether the receiving was from the network element or the DHCP server (step 552); and forwarding the modified DHCP packet to one of the network element and the DHCP server based on the receiving (step 553). The network element is configured to obtain an Internet Protocol (IP) address from the DHCP server and through the NAT gateway and communicate to a configuration server to download a configuration automatically subsequent to the configuration of the obtained IP address. The DHCP server can be in a different network address space from the network element.

The receiving from the network element and the forwarding to the network element are performed with a second DHCP Relay Agent between the network element and the first DHCP Relay Agent. The second DHCP Relay Agent can be configured to send the DHCP packet to a destination address of the first DHCP Relay Agent, and the modifying can include changing the destination address to an address of the DHCP server.

The receiving can be from the network element, and the forwarding is to the DHCP server, and wherein the modifying can include changing a Gateway Internet Protocol (IP) Address (GIADDR) from an address of the second DHCP Relay Agent to an address of the NAT gateway; adding a Link Selection Sub-option as the address of the second DHCP Relay Agent; and changing a destination IP address from the first DHCP Relay Agent to the DHCP server. The receiving can be from the DHCP server, and the forwarding can be to the network element via the second DHCP Relay Agent, and wherein the modifying can include changing a Gateway Internet Protocol (IP) Address (GIADDR) from an address of the NAT gateway to an address of the second DHCP Relay Agent; removing a Link Selection Sub-option as the address of the second DHCP Relay Agent; and changing a destination IP address from the NAT gateway to the second DHCP Relay Agent. The modifying the option 82 data can include adding a signature in a Vendor-Specific Information Sub-option for authentication of returning packets.

In another embodiment, a Dynamic Host Configuration Protocol (DHCP) Relay Agent operating on a Network Address Translation (NAT) gateway for low or zero touch provisioning of a network element through the NAT gateway includes a processor; and memory storing instructions that, when executed, cause the processor to receive a DHCP packet with option 82 data from one of the network element and a DHCP server; modify addressing and the option 82 data of the DHCP packet based on whether the DHCP packet was received from the network element or the DHCP server; and forward the modified DHCP packet to one of the network element and the DHCP server based on where it was received.

In a further embodiment, a network element configured for supporting low or zero touch provisioning through a Network Address Translation (NAT) gateway a plurality of modules interconnected to one another; and a Dynamic Host Configuration Protocol (DHCP) Relay Agent operating on one of the plurality of modules, wherein the DHCP Relay Agent is configured to communicate DHCP packets with option 82 data between a second DHCP Relay Agent configured on a NAT gateway; obtain an Internet Protocol (IP) address lease from a DHCP server through the second DHCP Relay Agent and the NAT gateway; and obtain configuration information from a configuration server subsequent to configuration of the IP address lease, wherein the network element is in a different address space from the DHCP server and the configuration server.

### ZTP Script

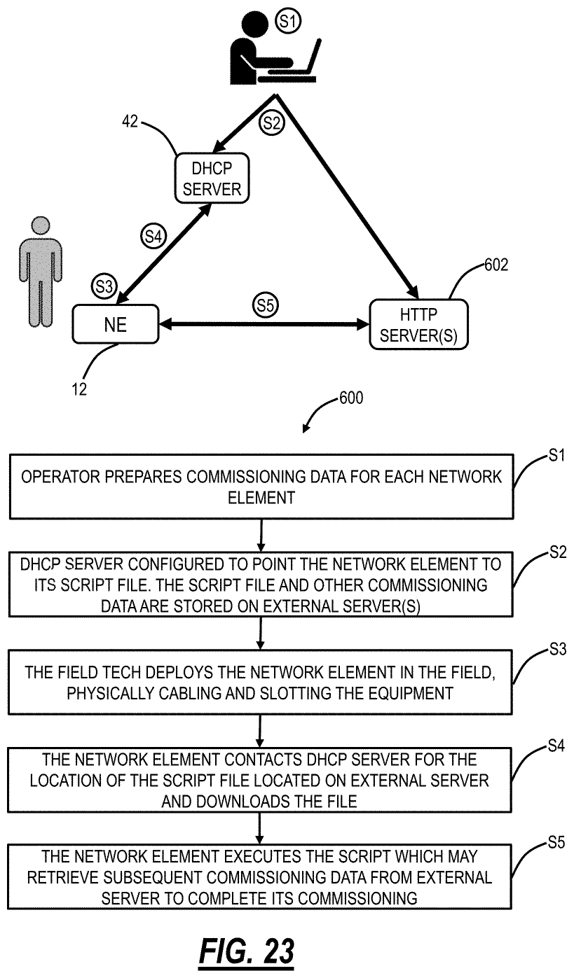

FIG. 23 is a flowchart and diagram of a script process 600 for ZTP provisioning. The script process 600 generally includes an operator preparing commissioning data for each network element (step S1). The commissioning data can be part of a script file (e.g., Python script). A DHCP server 42 is configured to point the network element 12 to its script file (step S2). A field technician deploys the network element 12 in the field, physically cabling and slotting the equipment (step S3). Here, the network element 12 is installed, powered on, and cabled to the network. The network element 12 contacts the DHCP server 42 for the location of the script file located on an external server 602 and downloads the file (step S4). The external server 602 can be a Hypertext Transfer Protocol (HTTP) server, the FTP server 44, etc. The network element 12 receives and executes the script file which may retrieve subsequent commissioning data from external server 602 to complete its commissioning (step S4).

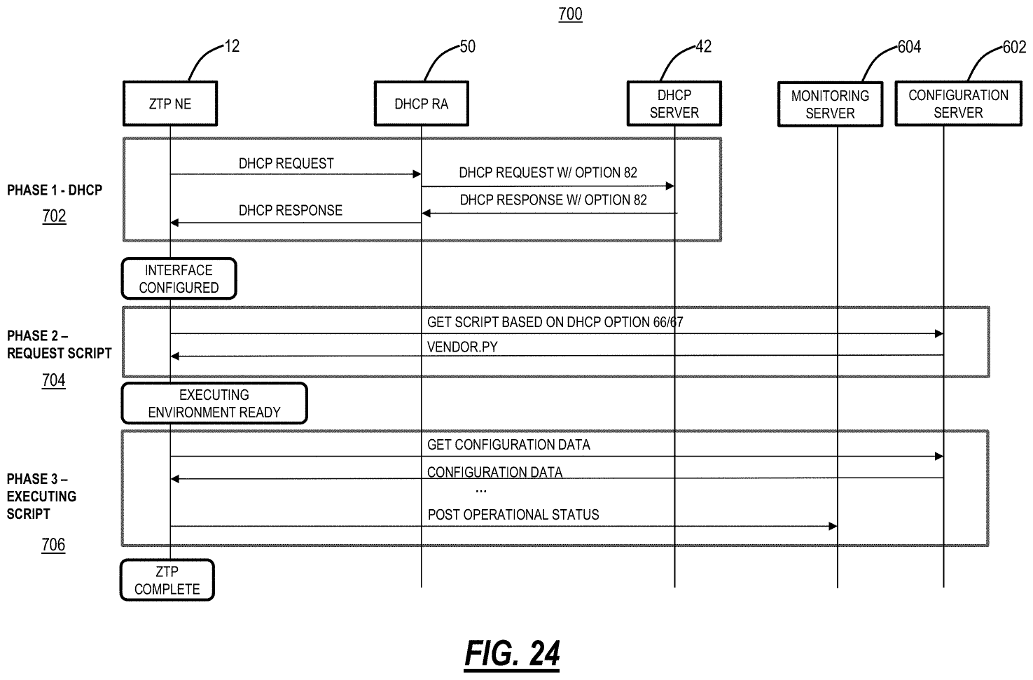

FIG. 24 is a flow diagram of a scripting process 700 with a network element 12 connecting to the DHCP Relay Agent 50 through a numbered interface. The scripting process 700 includes three phases 702, 704, 706. In the first phase 702, an IP address and default route are configured on the ZTP network element 12 through the DHCP protocol. The DHCP requests, preferably, include a network element 12 identifier number that can be used on the DHCP server 42 to correlate the script with the network element 12. The DHCP response then contains a Uniform Resource Locator (URL) to a script that the network element 12 should download and execute in the execution environment. Once the first phase 702 completes, the network element 12 is expected to be accessible by external servers 602, 604.

In the second phase 704, the network element 12 downloads the script based on the URL to a script specified in the DHCP response. The URL can be specified in the DHCP option 66 and 67. Once the second phase 704 completes, the ZTP network element 12 puts the script in an execution environment to execute it. Of note, the content of the script is not transparent to the ZTP network element 12 and is not known in advance.

In the third phase 706, the script is executed on the ZTP network element 12. Based on the content, the script might pull additional configuration files and/or software image from different sources such as different configuration servers and configure the ZTP network element 12 accordingly until complete. Meanwhile, the script may choose to report operational status to external servers such as monitoring servers 604 (e.g., Network Management System (NMS), Element Management System (EMS), etc.).

The interface on which the ZTP NE initiates DHCP negotiation can be either numbered or unnumbered. The numbered interface is one that has an IP address assigned to it in order to enable communication. The unnumbered interface is one that does not have a dedicated IP address. In accordance with the methods proposed herein, the unnumbered interface borrows an IP address from another numbered interface on the network element 12. The IP address is then called “borrowed” IP address. As described herein, the majority of the interfaces in the network element 12 can be configured as unnumbered to simplify the IP management because they all borrow the IP address of a (loopback) interface. Therefore, the network management software only needs to manage one IP address per network element 12.

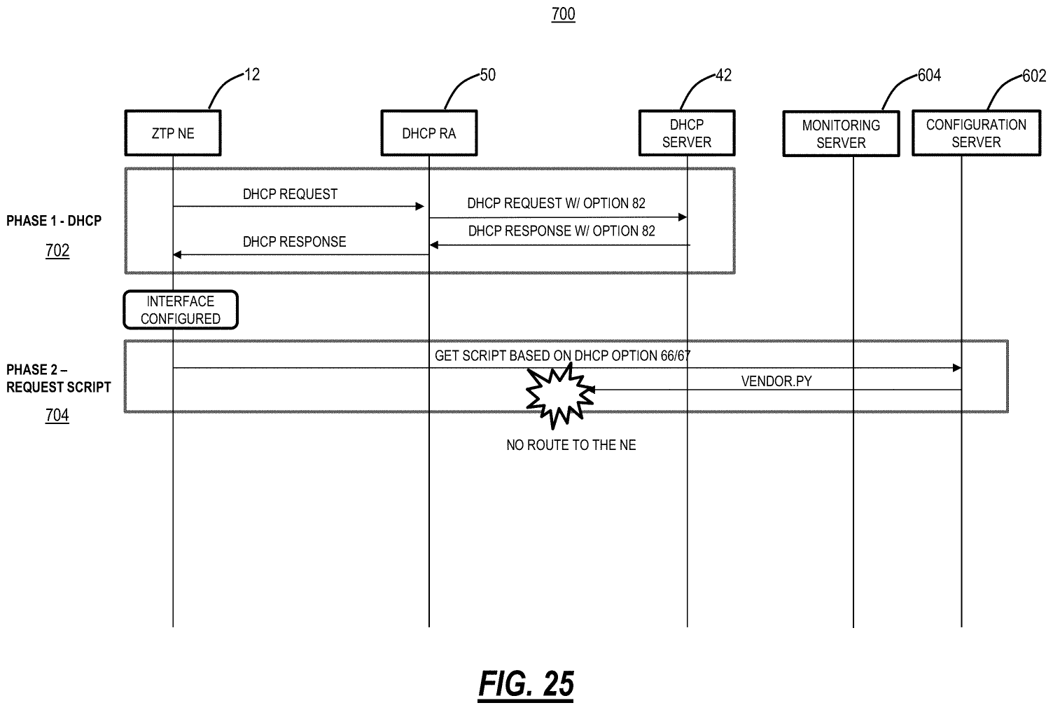

FIG. 25 is a flow diagram of the scripting process 700 with a network element 12 connecting to the DHCP Relay Agent 50 through an unnumbered interface, illustrating the problems associated therewith. As shown in FIG. 25, the scripting process 700 cannot work on unnumbered interfaces because, although the DHCP server 42 assigns an IP address to the unnumbered interface and the address can be used as the “borrowed” IP address of the interface, the address cannot be learned by the other network elements through the DHCP protocol (phase 702). Therefore, the other network elements do not know how to route the traffic to the interface. As shown in FIG. 25, it is assumed that the DHCP server 42 assigns an IP address to the ZTP network element 12 successfully and the address is configured as the “borrowed” IP address of the interface. In the second phase 704, the ZTP network element 12 sends a packet requesting to download the script from the configuration server 602 based on DHCP option 66/67. The source IP address of the packet is the “borrowed” IP address. The packet can reach the configuration server 602. As a response, the configuration server 602 sends the script file (e.g., Vendor.py) towards the ZTP network element 12 (i.e., the “borrowed” IP address). Since no intermediary network element knows the route to the “borrowed” IP address, the packet is dropped. Therefore, the ZTP network element 12 never receives the script file (e.g., Vendor.py) in the second phase 704.

### ZTP Scripting Process Over Unnumbered Interfaces

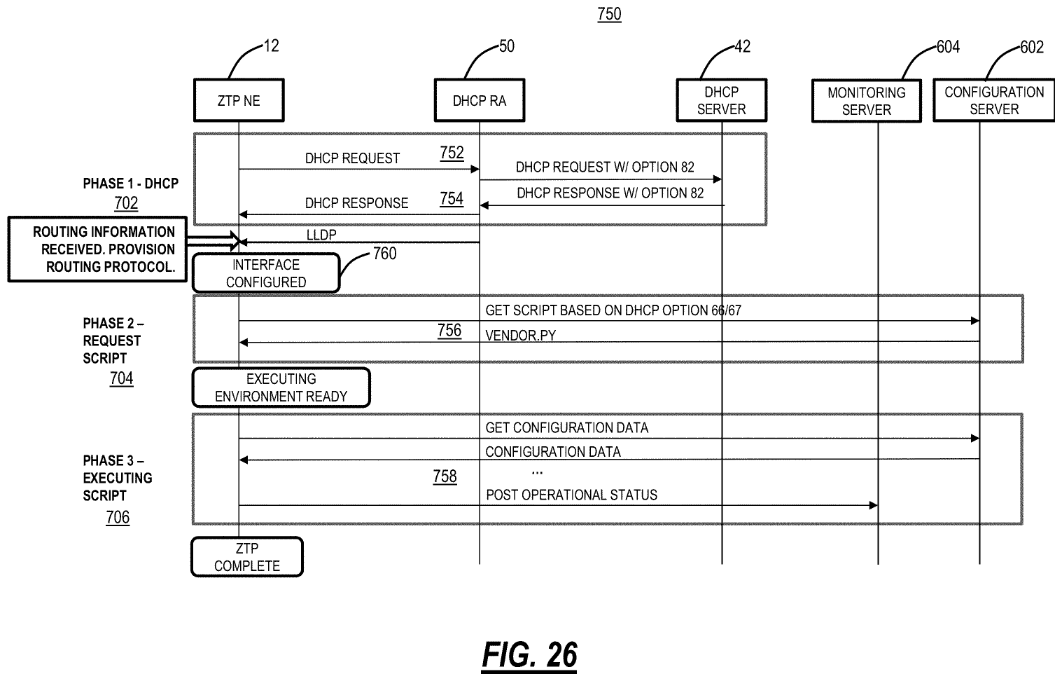

FIG. 26 is a flow diagram of a scripting process 750 with a network element 12 connecting to the DHCP Relay Agent 50 through an unnumbered interface and with the network element 12 learning the routing configuration. An approach to resolve the issues in FIG. 25 is to advertise the route to the ZTP network element 12 over the DCN network through a routing protocol. The systems and methods require the ZTP network element 12 to learn the routing configuration of the DHCP RA 50 and derive routing configuration accordingly, which enables the communication between the network elements. This approach is illustrated in FIG. 26 and the interface of the ZTP network element 12 connecting to the DHCP RA 50 is assumed to be unnumbered.

In the first phase 702, when the network element 12 boots up, it initiates DHCP requests to the DHCP server 42, such as through the DHCP RA 50 (step 752). When a DHCP lease is received on an unnumbered interface 760 via the DHCP response (step 754), the assigned IP address is configured as the “borrowed” IP address of the interface 760. The remote IP address of the unnumbered interface 760 is the gateway address specified by the DHCP option. Typically, the gateway is the IP address of the DHCP RA 50. The default route can be installed in terms of DHCP options.

After the first phase 702, there is an intermediate phase before the second phase 704. The intermediate phase is to set up a routing configuration for the unnumbered interface 760. The intermediate phase can include one of two approaches, namely Link Layer Discovery Protocol (LLDP) or protocol snooping, to set up routing configuration on the ZTP network element 12. Either of the two approaches can be used for setting up the routing configuration of the ZTP network element 12.

### LLDP to Set Up Routing Configuration

With the LLDP approach, the DHCP RA 50 supports the LLDP protocol on the interface connecting to the unnumbered interface 760 of the ZTP network element 12. With the LLDP approach, the DHCP RA 50 sends LLDP packets to the interface 760 of the ZTP network element 12 periodically broadcasting its own routing configuration. The ZTP network element 12 receives the LLDP packets and derives a routing configuration to match that of the DHCP RA 50 accordingly. After the routing configuration is applied, communication is established between the network element 12 and other devices on the DCN.

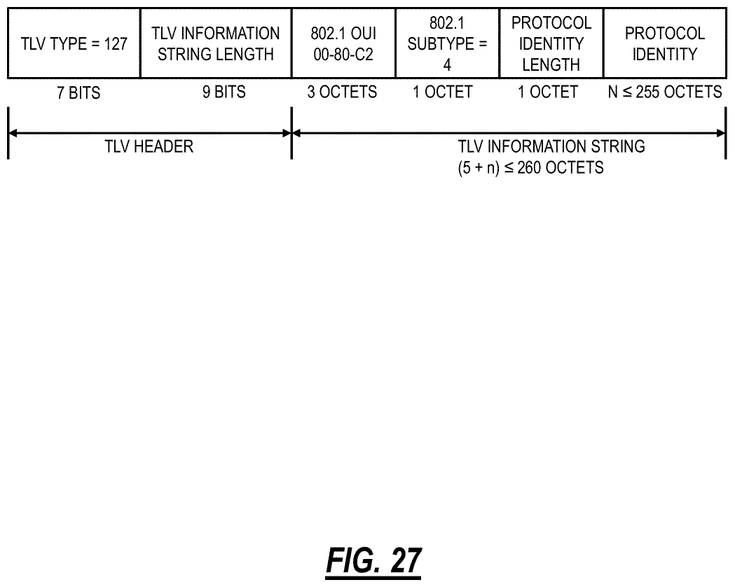

The DHCP RA 50 enables LLDP on its interface connecting to the unnumbered interface 760 of the ZTP network element 12. FIG. 27 is a block diagram of a protocol identity Type-Length-Value (TLV) 770 for use in the LLDP approach of the scripting process 750. The protocol identity TLV 770 can be included in LLDP packets as defined in IEEE 802.1ab, the contents of which are incorporated by reference herein. The protocol identity TLV 770 is an optional TLV, for example, defined in IEEE 802.1ab, that allows advertisement of protocols that are accessible through the port.

The TLV information string length field contains the length, in octets, of the (protocol identity+5). The protocol identity length field contains the length, in octets, of the protocol identity. The protocol identity field contains the first n octets of the protocol after the layer 2 addresses. The n octets can be used to identify a protocol. For Open Shortest Path First (OSPF), the field contains Ethernet type, IP header, and the first 36 octets of the OSPF hello packet. For Intermediate System-Intermediate System (ISIS), the field contains the first 8 octets of the ISIS packet. As an alternative, the protocol identity may contain necessary routing information that helps the ZTP network element 12 derive a routing configuration.

When ZTP network element 12 receives the LLDP packet sent by the DHCP RA 50 on the unnumbered interface, the ZTP network element 12 derives routing configuration based on the protocol identity TLV 770. If the protocol identity TLV 770 indicates that the OSPF protocol is provisioned on the DHCP RA 50, the area ID, network mask, hello interval and router dead interval are extracted from the protocol identity TLV 770. The OSPF router ID of the ZTP network element 12 is derived from the protocol identity TLV 770, e.g. the IP address assigned to the interface. With the information above, the OSPF router and the OSPF circuit on the unnumbered interface 760 can be created. The OSPF hello may not be authenticated through MD5.

If the protocol identity TLV 770 indicates that the ISIS protocol is provisioned on the DHCP RA 50, the ISIS router and the ISIS circuit on the unnumbered interface 760 shall be provisioned on the ZTP network element 12.

Once the above procedure is complete, the “borrowed” IP address can be advertised through the routing protocol, e.g., OSPF or ISIS and learned by other devices in the network. Therefore, the “borrowed” IP address can be reached by the external servers 602, 604.

### Protocol Snooping

If the LLDP protocol cannot be supported on the DHCP RA 50, the ZTP network element 12 can sniff the packets sent by the DHCP RA 50 on the corresponding unnumbered interface 760. If the received packets are OSPF Hello packets, the area ID, network mask, hello interval and router dead interval are extracted from the received OSPF Hello packets. The OSPF router ID of the ZTP network element 12 is derived from the IP address assigned to the interface. With the information above, the OSPF router and the OSPF circuit on the unnumbered interface 760 can be created. The OSPF hello may not be authenticated through MD5. If the received packets are ISIS Hello packets, the ISIS router and the ISIS circuit on the unnumbered interface 760 shall be provisioned on the ZTP network element 12.

Once the above procedure is complete, the “borrowed” IP address can be advertised through the routing protocol, e.g., OSPF or ISIS and learned by other devices in the network. Therefore, the “borrowed” IP address can be reached by the external servers 602, 604.

### ZTP Scripting Process Over Unnumbered Interfaces

Referring back to FIG. 26, after the intermediate phase and in the second phase 704, the ZTP network element 12 can be reached through the unnumbered interface 760 by the external servers 602, 604. Therefore, at this phase, the ZTP network element 12 can contact configuration servers acquiring the script based on the DHCP options 66/67 (step 756). In the third phase 706, the script is executed on the ZTP network element 12 which may contact the external servers 602, 604 for additional configurations (step 758).

### Secure ZTP

Customers (Service providers, network operators, data center operators, etc.) require the ZTP configuration to be transferred to the ZTP network element 12 in a secure way. The configuration shall not be read or modified by any third-party devices. The challenge is that the ZTP network element 12 (DHCP clients) may not have any knowledge of the password, certificate, etc. when it boots up.

The current solution for secure ZTP focuses on downloading the configuration via Secure FTP (SFTP) or HTTP Secure (HTTPS) instead of Trivial FTP (TFTP) which does not have security built in. For the SFTP solution, the issue is that the username and password must be provided on the ZTP network element 12. Therefore, the information must be either imprinted with the network element 12 at manufacture, or transferred via an unencrypted communication channel, or typed in via a console. All of these approaches create management and operational overhead on both the manufacture and customer side as well as security concerns on the customer side.

For the HTTPS-based solutions, the server's certificate should be validated using validation certificates from the Certificate Authority (CA). Since this scenario involves a newly commissioned network element 12, the network element 12 may not have the validation certificates to perform the validation. Transport Layer Security (TLS) validation would need to be disabled or would require pre-installation of certificates. Pre-installation of certificates would be time-limited as validation certificates have an expiry date associated with that certificate. If a network element 12 was not used for a long period of time, the certificate would be invalid. This limits the shelf life of the network element 12.

Systems and methods described herein provide a secure configuration transfer from the configuration server or the closest DHCP RA 50 to the network element 12 without preloading any password or certificate on the device.

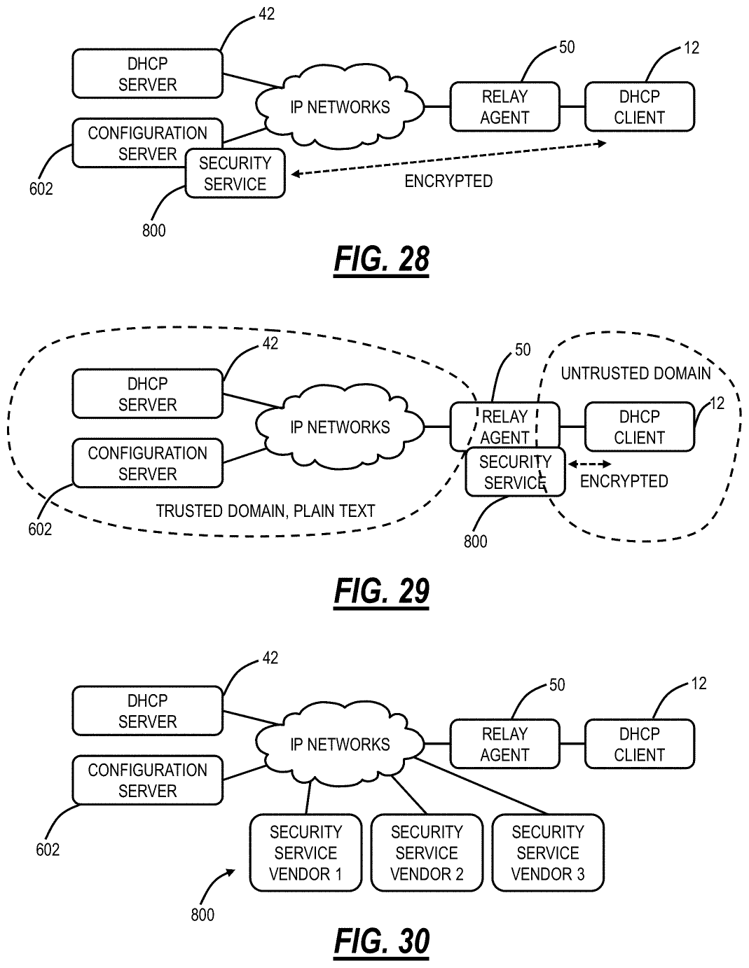

FIG. 28 is a network diagram with a security service 800 introduced in the ZTP system. The security service 800 can work collaboratively with the configuration server 602 to provide an end-to-end encrypted configuration transfer from the configuration server 602 to the DHCP client (the network element 12).

FIG. 29 is a network diagram with the security service 800 operating collaboratively with the DHCP RA 50 to provide an encrypted configuration transfer from the DHCP RA 50 to the DHCP client over an unnumbered link. In this configuration, the DHCP RA 50 along with customers' network infrastructure is deemed as within a trusted domain where the network elements can be authenticated with authentication services such as RADIUS. Therefore, the configuration file, as well as its location, do not require encryption. However, when the configuration is delivered to the DHCP client from its neighboring DHCP relay agent, it is encrypted via the security service to ensure unauthenticated parties are unable to obtain the configuration.

FIG. 30 is a network diagram where there are multiple security services 800 in a multi-vendor environment where multiple vendor's devices are mixed within the same networks. In this scenario, each vendor has its own security service 800 running on the networks. The configuration server 602 or the DHCP RA 50 dispatches the vendor class ID, client identifier, the DHCP transaction ID as well as the hardware address to the appropriate security server based on the vendor class ID. The server then returns the encryption key which is then used to encrypt the configuration by the configuration server or the relay agent.

The security service 800 requires a vendor class ID (DHCP option 60), client identifier (DHCP option 61), DHCP transaction ID as well as client hardware address to generate an encryption key which is then used by the configuration server 602 or the DHCP RA 50 to encrypt the configuration file.

The process of generating the encryption key is as follows:

First, the configuration server 602 or the DHCP RA 50 sends the vendor class ID, client identifier, DHCP transaction ID and client hardware address to the security service 800 requesting the encryption key.

Second, when the security service 800 receives this information, it concatenates the information as well as a vendor-specific secret which is only known by the vendor and an optional user password together into a single string. The vendor class ID, client identifier, DHCP transaction ID and client hardware address can be extracted from DHCP packets. The vendor specific secret is chosen by the vendor, and the value may be determined in terms of the vendor class ID. The vendor may choose different vendor-specific secret for its different product classes or product family. In most cases, the user password is optional. It can be applied to the edge nodes connecting different customers' networks to distinguish the identity of the customers. The process does not have a restriction on the content of the string. Other content in the DHCP message can also be attached to the string.

Third, the string is then passed through a hash algorithm (such as MD5, SHA, etc.). An encryption key is generated through the algorithm and sent back to the configuration server 602 or the DHCP RA 50.

Fourth, the configuration server 602 or DHCP RA 50 can then use the encryption key to encrypt the configuration. For example, AES is employed as the encryption cipher. In order to perform AES encryption, the encryption key and an Initialization Vector (IV) are used. For example, the encryption key is the one that is received, and the IV is set to zero.

When the DHCP client receives the configuration, it knows its own vendor class ID, client identifier, active DHCP transaction ID, the hardware address of the incoming interface, the vendor-specific secret that it should use and user password, if applicable. Therefore, it runs the process step 2 and 3 to generate an encryption key and uses it to decipher the configuration. Once the configuration is deciphered, the configuration data must be validated via approaches such as magic number detection, digital signature, etc.

The DHCP client is not able to decipher and validate the configuration properly if the configuration is not intended for it, detected by client identifier; is for the wrong product type, detected by the vendor-specific secret; an expired DHCP transaction, detected by DHCP transaction ID; coming from the incorrect interface, detected by client hardware address; or the configuration does not come from the expected operator, detected by user password.

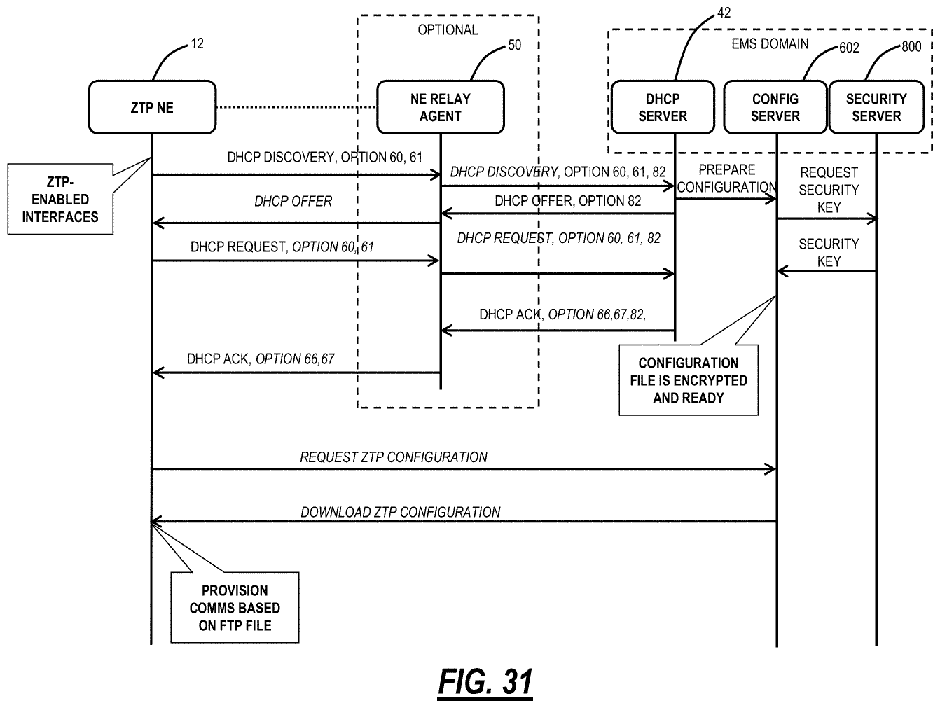

FIG. 31 is a flow diagram of message sequences using the security service 800. The process disclosed herein establishes a secure configuration transfer from the configuration server 602 to the network element 12 requesting zero touch provisioning without pre-loading user password. The process provides a network configuration where the network can support and manage secure zero touch provisioning across multiple vendors' devices. When devices belonging to different operators require to interoperate with each other, the user password, as an option, can be used to distinguish between the operators. The process is a software solution which has a lower cost compared with hardware solutions.

The secure ZTP provides the flexibility to meet different operator's security requirements. In a single operator's network, the operator does not need to pre-configure any key or password on the devices requesting ZTP. The configuration is encrypted and automatically associated to a specific DHCP transaction of a specific device via a specific interface. In multiple operators' networks, a user password can be used to configure the edge devices that interoperate with other operators' devices. The password can be used to assist the edge devices requesting zero touch provisioning to decipher the configuration and authenticate the data as its own.

The secure ZTP also provides a network configuration where the network can support secure ZTP across multiple vendors' devices using the same process described herein. The process guarantees the encryption key is generated privately by each vendor, allows the configuration to be encrypted on any other devices and guarantees the encrypted configuration can only be interpreted by the proper device and not readable by third-party devices.

The encryption key can be associated with the vendor class ID, client identifier, DHCP transaction ID, the interface hardware address, the vendor-specific secret and user password. This association prevents man-in-the-middle attacks (e.g., replay attack, spoofing attack, injection attack, etc.) in the network.

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A method of low or zero touch provisioning of a network element over an unnumbered interface, the method comprising:
subsequent to installation and connection of the network element to a network, obtaining an Internet Protocol (IP) address from a Dynamic Host Configuration Protocol (DHCP) server through a DHCP Relay Agent, wherein the IP address is for another interface associated with the network element;
performing routing configuration of the unnumbered interface based on data obtained from the DHCP Relay Agent;
requesting a script from an external server subsequent to the routing configuration; and
receiving the script from the external server and executing the script to perform configuration of the network element.

2. The method of claim 1, wherein the performing routing configuration comprises the DHCP Relay Agent providing Link Layer Discovery Protocol (LLDP) packets to the network element.

3. The method of claim 2, wherein the data obtained from the DHCP Relay Agent is in a protocol identity Type-Length-Value (TLV) in the LLDP packets.

4. The method of claim 1, wherein the routing configuration is one of Open Shortest Path First (OSPF) and Intermediate System-Intermediate System (ISIS).

5. The method of claim 1, wherein the performing routing configuration comprises the network element sniffing packets sent by the DHCP Relay Agent on the unnumbered interface.

6. The method of claim 1, wherein the obtaining the IP address utilizes option 82 from the DHCP Relay Agent to the DHCP server.

7. The method of claim 1, wherein the requesting the script utilizes DHCP option 66 or 67.

8. The method of claim 1, further comprising:
prior to the installation and the connection, storing commissioning data and the script for the network element.

9. A network element comprising:
one or more modules;
one or more switch modules interconnecting the one or more modules; and
a plurality of interfaces communicatively coupled to the one or more modules and the one or more switch modules, at least one of the plurality of interfaces comprises an unnumbered interface,
wherein subsequent to installation and connection of the one or more modules to a network, the unnumbered interface obtains an Internet Protocol (IP) address from a Dynamic Host Configuration Protocol (DHCP) server through a DHCP Relay Agent, wherein the IP address is for another interface of the plurality of interfaces,
wherein a routing configuration is performed for the unnumbered interface based on data obtained from the DHCP Relay Agent, and
wherein, subsequent to the routing configuration, a script is requested via the unnumbered interface from an external server, and, subsequent to receipt of the script, the script is executed to perform configuration of the network element.

10. The network element of claim 9, wherein the routing configuration includes receipt of Link Layer Discovery Protocol (LLDP) packets from the DHCP Relay Agent.

11. The network element of claim 10, wherein the data obtained from the DHCP Relay Agent is in a protocol identity Type-Length-Value (TLV) in the LLDP packets.

12. The network element of claim 9, wherein the routing configuration is one of Open Shortest Path First (OSPF) and Intermediate System-Intermediate System (ISIS).

13. The network element of claim 9, wherein the routing configuration comprises the network element sniffing packets sent by the DHCP Relay Agent on the unnumbered interface.

14. The network element of claim 9, wherein the IP address is obtained using option 82 from the DHCP Relay Agent to the DHCP server.

15. The network element of claim 9, wherein the script is requested using DHCP option 66 or 67.

16. The network element of claim 9, wherein, prior to the installation and the connection, commissioning data and the script are stored for the network element.

17. A Dynamic Host Configuration Protocol (DHCP) Relay Agent for low or zero touch provisioning, the DHCP Relay Agent comprising:
a processor; and
memory storing instructions that, when executed, cause the processor to
receive and relay Dynamic Host Configuration Protocol (DHCP) messages between an unnumbered interface on a network element and a DHCP server, wherein the DHCP messages provide an Internet Protocol (IP) address which is for another interface associated with the network element, and
provide routing configuration data to the unnumbered interface such that the unnumbered interface configures routing,
wherein the routing configuration is one of Open Shortest Path First (OSPF) and Intermediate System-Intermediate System (ISIS),
wherein the network element utilizes the routing configuration to configure the unnumbered interface such that the unnumbered interface requests and receives a script for configuration of the network element.

18. The DHCP Relay Agent of claim 17, wherein the routing configuration data is provided via Link Layer Discovery Protocol (LLDP) packets to the unnumbered interface.

19. The DHCP Relay Agent of claim 18, wherein the LLDP packets include a protocol identity Type-Length-Value (TLV).

20. The DHCP Relay Agent of claim 17, wherein the DHCP messages are provided via DHCP option 82 between the DHCP Relay Agent to the DHCP server.
